(19) United States
(12) Patent Application Publication
(10) Pub. No.: US 2025/0056230 A1
(43) Pub. Date: Feb. 13, 2025

(54) SYSTEM INFORMATION VERIFICATION METHOD, COMMUNICATION APPARATUS, AND STORAGE MEDIUM

(71) Applicant: Beijing Xiaomi Mobile Software Co., Ltd., Beijing (CN)

(72) Inventors: Yumin WU, Beijing (CN); Rao SHI, Beijing (CN)

(73) Assignee: Beijing Xiaomi Mobile Software Co., Ltd., Beijing (CN)

(21) Appl. No.: 18/717,731

(22) PCT Filed: Dec. 7, 2021
(86) PCT No.: PCT/CN2021/136199

§ 371 Date: Jun. 7, 2024

(51) Int. Cl. H04W 12/08; H04W 48/16

(52) U.S. Cl. CPC H04W 12/08; H04W 48/16

(57) ABSTRACT

System information verification methods, communication apparatuses, and storage mediums that improve security of a wireless communication network. The security is improved by: sending auxiliary information to a network-side device, wherein the auxiliary information comprises at least one of a verification manner supported by UE, information of a verification algorithm supported by the UE, an identifier of system information expected to be verified by the UE, an identifier of system information received by the UE, an identifier of system information of interest of the UE, or first indication information for indicating that the UE expects system information verification; and triggering, based on information sent by the network-side device, correctness verification for system information.

### CROSS-REFERENCE TO RELATED APPLICATIONS

The present disclosure is a U.S. national phase of PCT Application No. PCT/CN2021/136199 filed on Dec. 7, 2021, the content of which is hereby incorporated by reference in its entirety.

### TECHNICAL FIELD

The present disclosure relates to a field of communication technologies, and in particular, to system information verification methods, communication apparatuses, and storage mediums.

### BACKGROUND

In a communication system, correctness verification is usually executed on system information. In a related art, correctness verification for system information mainly includes following. User equipment (UE) executes calculation on received system information through a verification algorithm to obtain a first value, a network-side device executes calculation on the sent system information through a verification algorithm to obtain a second value, the network-side device may send the second value to the UE, and the UE verifies the system information by comparing whether the first value matches the second value; or the UE may send the first value to the network-side device, and the network-side device verifies the system information by comparing whether the first value matches the second value.

### SUMMARY

The present disclosure provides system information verification methods, communication apparatuses, and storage mediums.

An embodiment in a first aspect of the present disclosure provides a system information verification method. The method is applied to UE, and includes:
sending auxiliary information to a network-side device; where the auxiliary information includes at least one of: a verification manner supported by the UE, information of a verification algorithm supported by the UE, an identifier of system information expected to be verified by the UE, an identifier of system information received by the UE, an identifier of system information of interest of the UE, or first indication information indicating that the UE expects system information verification; and
obtaining information that is sent by a network-side device based on the auxiliary information, and triggering correctness verification for system information based on information sent by the network-side device.

An embodiment in a second aspect of the present disclosure provides a system information verification method. The method is applied to a network-side device, and includes:
obtaining auxiliary information sent by UE; where the auxiliary information includes at least one of: a verification manner supported by the UE, information of a verification algorithm supported by the UE, an identifier of system information expected to be verified by the UE, an identifier of system information received by the UE, an identifier of system information of interest of the UE, or first indication information indicating that the UE expects system information verification; and
triggering correctness verification for system information based on the auxiliary information.

An embodiment in a third aspect of the present disclosure provides a communication apparatus. The communication apparatus includes a processor and an interface circuit;
where the interface circuit is configured to receive code instructions and transmit the code instructions to the processor; and
the processor is configured to execute the code instructions to execute the method provided in the embodiment in an aspect.

An embodiment in a fourth aspect of the present disclosure provides a communication apparatus. The communication apparatus includes a processor and an interface circuit;
where the interface circuit is configured to receive code instructions and transmit the code instructions to the processor; and
the processor is configured to execute the code instructions to execute the method provided in the embodiment in another aspect.

An embodiment in a fifth aspect of the present disclosure provides a computer-readable storage medium, configured to store instructions. When the instructions are executed, the method provided in the embodiment in an aspect is implemented.

An embodiment in a sixth aspect of the present disclosure provides a computer-readable storage medium, configured to store instructions. When the instructions are executed, the method provided in the embodiment in another aspect is implemented.

In addition, in the embodiments of the present disclosure, after the correctness verification is executed for the system information, whether the system information is subjected to a security problem is further determined, and when the system information is subjected to a security problem, the UE executes a corresponding operation (that is, triggering the connection release, and/or triggering the connection reconstruction, and/or reporting the fifth indication information to the network-side device), which thereby may achieve the purpose of “executing the differentiated control on the UE for which the system information verification fails according to different security requirements of the UE.”

### BRIEF DESCRIPTION OF DRAWINGS

The above and/or additional aspects and advantages of the present disclosure will become apparent and readily understood from the following description of embodiments in combination with the accompanying drawings.

FIG. 1 is a schematic flowchart of a system information verification method provided by an embodiment of the present disclosure.

FIG. 2 is a schematic flowchart of a system information verification method provided by another embodiment of the present disclosure.

FIG. 3 is a schematic flowchart of a system information verification method provided by still another embodiment of the present disclosure.

FIG. 4a is a schematic flowchart of a system information verification method provided by yet another embodiment of the present disclosure.

FIG. 4b is a schematic flowchart of a system information verification method provided by yet another embodiment of the present disclosure.

FIG. 5 is a schematic flowchart of a system information verification method provided by yet another embodiment of the present disclosure.

FIG. 6 is a schematic flowchart of a system information verification method provided by yet another embodiment of the present disclosure.

FIG. 7 is a schematic flowchart of a system information verification method provided by yet another embodiment of the present disclosure.

FIG. 8 is a schematic flowchart of a system information verification method provided by yet another embodiment of the present disclosure.

FIG. 9 is a schematic flowchart of a system information verification method provided by yet another embodiment of the present disclosure.

FIG. 10a is a schematic flowchart of a system information verification method provided by yet another embodiment of the present disclosure.

FIG. 10b is a schematic flowchart of a system information verification method provided by yet another embodiment of the present disclosure.

FIG. 11 is a schematic flowchart of a system information verification method provided by yet another embodiment of the present disclosure.

FIG. 12 is a schematic flowchart of a system information verification method provided by yet another embodiment of the present disclosure.

FIG. 13 is a schematic structural diagram of a system information verification apparatus provided by an embodiment of the present disclosure.

FIG. 14 is a schematic structural diagram of a system information verification apparatus provided by another embodiment of the present disclosure.

FIG. 15 is a block diagram of user equipment provided by an embodiment of the present disclosure.

FIG. 16 is a block diagram of a network-side device provided by an embodiment of the present disclosure.

### DETAILED DESCRIPTION

Exemplary embodiments will be described in details herein, with examples thereof represented in the accompanying drawings. When the following description involves the accompanying drawings, same numerals in different figures represent same or similar elements unless otherwise indicated. Implementations described in the following exemplary embodiments do not represent all implementations consistent with embodiments of the present disclosure. On the contrary, they are only examples of apparatuses and methods that are consistent with some aspects of embodiments of the present disclosure as detailed in the attached claims.

Terms used in the embodiments of the present disclosure are only for a purpose of describing specific embodiments, and are not intended to limit the embodiments of the present disclosure. Singular forms, “a/an” and “the” used in the embodiments and the appended claims of the present disclosure are also intended to include majority forms, unless the context clearly indicates other meanings. It should also be understood that the term “and/or” used herein refers to and includes any or all possible combinations of one or more related listed items.

It should be understood that although terms, such as “first,” “second,” “third,” etc., may be used in the embodiments of the present disclosure to describe various information, such information should not be limited by these terms. These terms are only used to distinguish a same type of information from each other. For example, without departing from the scope of the embodiments of the present disclosure, first information may also be referred to as second information, and similarly, the second information may also be referred to as the first information. Depending on the context, terms “if” and “in a case where” used herein may be interpreted as “when,” “while,” or “in response to determining.”

However, in the related art, the verification algorithm supported by the UE may be different from the verification algorithm supported by the network-side device, such that the first value does not match the second value, which reduces accuracy of the system information verification. In addition, in the related art, when it is determined that the system information verification fails, differentiated control cannot be executed on the UE, for which the system information verification fails, according to different security requirements of the UE.

System information verification methods and apparatuses, user equipment, a network-side device, and storage mediums provided by the embodiments of the present disclosure will be described in detail below with reference to the accompanying drawings.

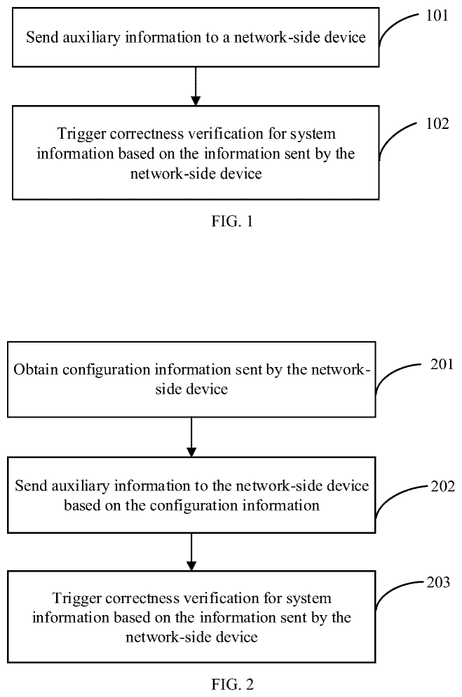

FIG. 1 is a schematic flowchart of a system information verification method provided by an embodiment of the present disclosure. The method is executed by UE. As shown in FIG. 1, the system information verification method may include the following steps 101-102.

At step 101, auxiliary information is sent to a network-side device.

In an embodiment of the present disclosure, the UE may be a device providing voice and/or data connectivity to a user. A terminal device may communicate with one or more core networks through a radio access network (RAN). The UE may be an Internet of Things terminal, such as a sensor device, a mobile phone (or referred to as a “cellular” phone), and a computer having the Internet of Things terminal, for example, a fixed, portable, pocket, handheld, computer built-in, or vehicle-mounted apparatus. For example, the UE may be a station (STA), a subscriber unit, a subscriber station, a mobile station, a mobile table, a remote station, an access point, a remote terminal, an access terminal, a user terminal, or a user agent. Alternatively, the UE may be a device of an unmanned aerial vehicle. Alternatively, the UE may be a vehicle-mounted device, for example, a vehicle computer having a wireless communication function, or a wireless terminal externally connected to a vehicle computer. Alternatively, the UE may also be a roadside device, for example, a street lamp, a signal light, other roadside device, etc., having a wireless communication function.

In addition, in an embodiment of the present disclosure, the auxiliary information may include at least one of: a verification manner supported by the UE, information of a verification algorithm supported by the UE, an identifier of system information expected to be verified by the UE, an identifier of system information received by the UE, an identifier of system information of interest of the UE, or first indication information indicating that the UE expects system information verification.

In an embodiment of the present disclosure, the above verification manner may include the following.

The UE executes the correctness verification for system information, that is, the UE executes the step of “verifying whether the value obtained by the network-side device executing calculation on the system information matches the value obtained by the UE executing calculation on the system information”.

The network-side device executes the correctness verification for system information, that is, the network-side device executes the step of “verifying whether the value obtained by the network-side device executing calculation on the system information matches the value obtained by the UE executing calculation on the system information”.

In an embodiment of the present disclosure, the above information of the verification algorithm supported by the UE may include at least one of the following.

One is an algorithm type identifier of the verification algorithm supported by the UE. For example, in an embodiment of the present disclosure, the algorithm type identifier may include a type identifier of at least one algorithm of: a checksum algorithm, an XOR check algorithm, a CRC (cyclic redundancy check) algorithm, a hash check algorithm, or a hashing check algorithm.

One is an algorithm identifier of the verification algorithm supported by the UE. For example, in an embodiment of the present disclosure, the algorithm identifier may include an algorithm identifier of at least one algorithm of: an MD3 (message-digest algorithm 3), an MD4, an MD5, or an SHA-1 (secure hash algorithm 1).

Further, in an embodiment of the present disclosure, the above system information expected to be verified by the UE may be one or more of system information received by the UE. For example, the system information expected to be verified by the UE may be an SIBx (system information block x), where x is an integer.

It should be noted that, in an embodiment of the present disclosure, when the UE expects to obtain higher system information security protection, the UE may directly send the above auxiliary information to the network-side device, such that the network-side device may trigger a subsequent flow of the system information verification based on the auxiliary information, to implement higher system information security protection.

At step 102, correctness verification for system information is triggered based on information sent by the network-side device.

In an embodiment of the present disclosure, when using different verification manners to verify, the network-side device sends different information, and different correctness verification for system information are also triggered. Detailed description of this part may refer to the description of subsequent embodiments.

In addition, in an embodiment of the present disclosure, the above system information may be broadcast by the network-side device to the UE. In another embodiment of the present disclosure, the above system information may be sent by the network-side device to the UE through dedicated signalling.

To sum up, in the system information verification method provided by the embodiment of the present disclosure, the UE sends auxiliary information to the network-side device, obtains information that is sent by the network-side device based on the auxiliary information, and triggers correctness verification for system information based on information sent by the network-side device. The auxiliary information includes at least one of: a verification manner supported by the UE, information of a verification algorithm supported by the UE, an identifier of system information expected to be verified by the UE, an identifier of system information received by the UE, an identifier of system information of interest of the UE, or first indication information indicating that the UE expects system information verification. Therefore, in the embodiment of the present disclosure, the UE first reports the verification algorithm supported by the UE to the network-side device, such that the network-side device may determine, based on the verification algorithm supported by the UE, a verification algorithm used in a subsequent correctness verification for system information, and indicate the verification algorithm to the UE. Therefore, when the correctness verification for system information is executed subsequently, it may be ensured that the network-side device and the UE use a same verification algorithm, which improves the accuracy of the system information verification.

FIG. 2 is a schematic flowchart of a system information verification method provided by an embodiment of the present disclosure. The method is executed by UE. As shown in FIG. 2, the system information verification method may include the following steps 201-203.

At step 201, configuration information sent by the network-side device is obtained.

In an embodiment of the present disclosure, the configuration information may include at least one of:
a verification manner supported by the network-side device;
an area identifier of system information supporting verification;
a first request message for requesting the UE to report whether the UE is capable of supporting system information verification, and/or the information of the verification algorithm supported by the UE;
a second request message for requesting the UE to report the identifier of the system information expected to be verified by the UE;
a third request message for requesting the UE to report the identifier of the system information received by the UE; or
a fourth request message for requesting the UE to report the identifier of the system information of interest of the UE.

The related description of the above verification manner and verification algorithm supported by the UE may refer to the description of in the above embodiments, which will not be repeated here in the embodiment of the present disclosure.

Further, in an embodiment of the present disclosure, the above area identifier of the system information supporting verification may include at least one of the following.

One is a cell identifier of the system information supporting verification. For example, the cell identifier may be a cell-1.

One is a cell type identifier of the system information supporting verification. For example, the cell type identifier may be at least one of: a PCell (primary cell) identifier, a PSCell (primary secondary cell) identifier, or an SCell (secondary cell) identifier.

One is a cell group type identifier of the system information supporting verification. For example, the cell group type identifier may be at least one of: an MCG (master cell group) identifier, or an SCG (secondary cell group) identifier.

One is a tracking area identifier of the system information supporting verification. For example, the tracking area identifier may be a TAC-1 (tracking area code) identifier.

One is an access network notification area identifier of the system information supporting verification. For example, the access network notification area identifier may be an RNA-1 (RAN-based notification area) identifier.

In addition, in an embodiment of the present disclosure, the obtaining configuration information sent by the network-side device is realized by the UE by at least one of the following.

The UE obtains the configuration information sent by the network-side device through a broadcast message. The broadcast message may be for example an SIBx, where x is a positive integer.

The UE obtains the configuration information sent by the network-side device through a dedicated configuration message. The dedicated configuration message may be for example a radio resource control (RRC) reconfiguration message.

At step 202, auxiliary information is sent to the network-side device based on the configuration information.

At step 203, correctness verification for system information is triggered based on information sent by the network-side device.

In an embodiment of the present disclosure, when using different verification manners to verify subsequently, the network-side device sends different information, and different correctness verification for system information are also triggered. Detailed description of this part may refer to the description of subsequent embodiments, which will not be repeated here in the embodiment of the present disclosure.

To sum up, in the system information verification method provided by the embodiment of the present disclosure, the UE sends auxiliary information to the network-side device, obtains information that is sent by the network-side device based on the auxiliary information, and triggers correctness verification for system information based on information sent by the network-side device. The auxiliary information includes at least one of: a verification manner supported by the UE, information of a verification algorithm supported by the UE, an identifier of system information expected to be verified by the UE, an identifier of system information received by the UE, an identifier of system information of interest of the UE, or first indication information indicating that the UE expects system information verification. Therefore, in the embodiment of the present disclosure, the UE first reports the verification algorithm supported by the UE to the network-side device, such that the network-side device may determine, based on the verification algorithm supported by the UE, a verification algorithm used in a subsequent correctness verification for system information, and indicate the verification algorithm to the UE. Therefore, when the correctness verification for system information is executed subsequently, it may be ensured that the network-side device and the UE use a same verification algorithm, which improves the accuracy of the system information verification.

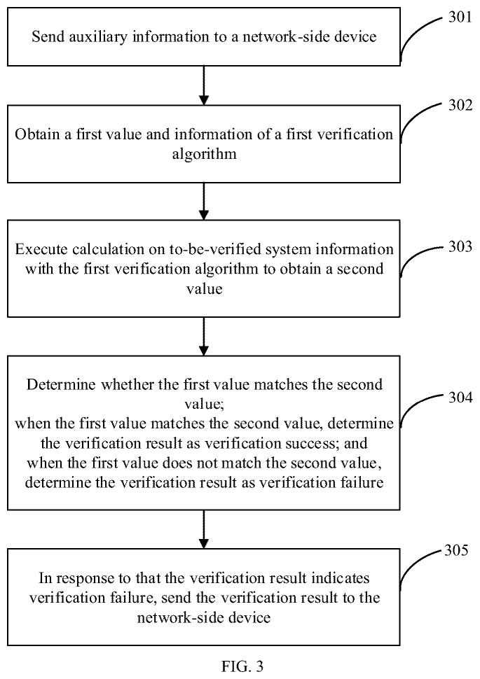

FIG. 3 is a schematic flowchart of a system information verification method provided by an embodiment of the present disclosure. The method is executed by the UE, and a verification manner in this embodiment includes: executing, by the UE, the correctness verification for system information. As shown in FIG. 3, the system information verification method may include the following steps 301-305.

At step 301, auxiliary information is sent to a network-side device.

In an embodiment of the present disclosure, the auxiliary information may include at least one of: a verification manner supported by the UE, information of a verification algorithm supported by the UE, an identifier of system information expected to be verified by the UE, an identifier of system information received by the UE, an identifier of system information of interest of the UE, or first indication information indicating that the UE expects system information verification.

In addition, the related description of the step 301 may refer to the description of the above embodiments, which will not be repeated here in the embodiment of the present disclosure.

At step 302, a first value and information of a first verification algorithm are obtained.

In an embodiment of the present disclosure, the first verification algorithm may be any one of verification algorithms supported by the UE. For example, the first verification algorithm may be a checksum algorithm, a hash check algorithm, an MD3, or the like.

In addition, in an embodiment of the present disclosure, the information of the first verification algorithm may be obtained by the UE by at least one of:
determining the information of the first verification algorithm based on a protocol convention; or
obtaining the information of the first verification algorithm indicated by the network-side device.

In an embodiment of the present disclosure, the information of the first verification algorithm may be indicated by the network-side device by at least one of:
indicating the information of the first verification algorithm to the UE through a security mode command; or
indicating the information of the first verification algorithm to the UE through other dedicated signalling other than the security mode command. The other dedicated signalling may include for example RRC reconfiguration information and/or downlink (DL) information transfer information.

Further, in an embodiment of the present disclosure, the above first value may be obtained by the network-side device using the first verification algorithm to execute calculation on the to-be-verified system information. In an embodiment of the present disclosure, the to-be-verified system information may be at least one of: the system information expected to be verified by the UE, the system information received by the UE, or the system information of interest of the UE. In addition, in an embodiment of the present disclosure, the first verification algorithm may be determined by the network-side device by: determining, by the network-side device, the first verification algorithm autonomously from verification algorithms supported by the UE, and/or determining, by the network-side device, the first verification algorithm based on the protocol convention.

Further, in an embodiment of the present disclosure, the first value may be obtained by the UE by: obtaining the first value sent by the network-side device.

In an embodiment of the present disclosure, the first value may be sent by the network-side device by at least one of:
sending the first value to the UE through a security mode command; or
sending the first value to the UE through other dedicated signalling other than the security mode command. The other dedicated signalling may include for example RRC reconfiguration information and/or DL information transfer information.

At step 303, calculation is executed on to-be-verified system information with the first verification algorithm to obtain a second value.

At step 304, whether the first value matches the second value is determined; when the first value matches the second value, the verification result is determined as verification success; and when the first value does not match the second value, the verification result is determined as verification failure.

In an embodiment of the present disclosure, in response to that the verification result indicates verification success, it indicates that transmission of the to-be-verified system information succeeds, and in response to that the verification result indicates verification failure, it indicates that the transmission of the to-be-verified system information fails.

At step 305, in response to that the verification result indicates verification failure, the verification result is sent to the network-side device.

In an embodiment of the present disclosure, the verification result may be sent by the UE to the network-side device by at least one of:
sending the verification result to the network-side device through the security mode command; or
sending the verification result to the network-side device through other dedicated signalling than the security mode command. The other dedicated signalling may include for example radio resource control (RRC) connection reconfiguration complete information or uplink (UL) information transfer information.

In addition, in an embodiment of the present disclosure, when the UE determines the verification result as verification failure, it indicates that the to-be-verified system information is not successfully transmitted, and in this case, the UE may send the verification result to the network-side device, such that the network-side device re-sends the system information to the UE based on the verification result.

To sum up, in the system information verification method provided by the embodiment of the present disclosure, the UE sends auxiliary information to the network-side device, obtains information that is sent by the network-side device based on the auxiliary information, and triggers correctness verification for system information based on information sent by the network-side device. The auxiliary information includes at least one of: a verification manner supported by the UE, information of a verification algorithm supported by the UE, an identifier of system information expected to be verified by the UE, an identifier of system information received by the UE, an identifier of system information of interest of the UE, or first indication information indicating that the UE expects system information verification. Therefore, in the embodiment of the present disclosure, the UE first reports the verification algorithm supported by the UE to the network-side device, such that the network-side device may determine, based on the verification algorithm supported by the UE, a verification algorithm used in a subsequent correctness verification for system information, and indicate the verification algorithm to the UE. Therefore, when the correctness verification for system information is executed subsequently, it may be ensured that the network-side device and the UE use a same verification algorithm, which improves the accuracy of the system information verification.

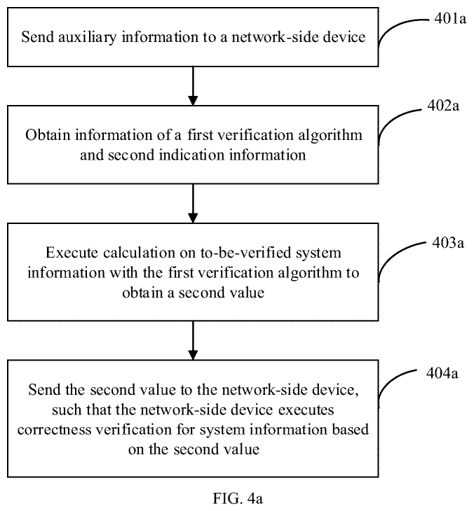

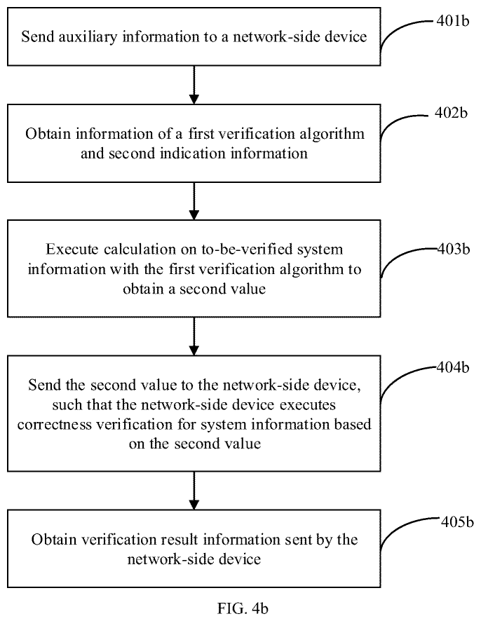

FIG. 4a is a schematic flowchart of a system information verification method provided by an embodiment of the present disclosure. The method is executed by the UE, and a verification manner in this embodiment includes: executing, by the network-side device, the correctness verification for system information. As shown in FIG. 4a, the system information verification method may include the following steps 401a-404a.

At step 401a, auxiliary information is sent to a network-side device.

In an embodiment of the present disclosure, the auxiliary information may include at least one of: a verification manner supported by the UE, information of a verification algorithm supported by the UE, an identifier of system information expected to be verified by the UE, an identifier of system information received by the UE, an identifier of system information of interest of the UE, or first indication information indicating that the UE expects system information verification.

In addition, other description of the step 401 may refer to the description of the above embodiments, which will not be repeated here in the embodiment of the present disclosure.

At step 402a, information of a first verification algorithm and second indication information are obtained.

The information of the first verification calculation and a manner of obtaining the information of the first verification calculation may refer to the description of in the above embodiments, which will not be repeated here in the embodiment of the present disclosure.

In addition, in an embodiment of the present disclosure, the second indication information is to instruct the UE to execute the correctness verification for system information.

In addition, in an embodiment of the present disclosure, the second indication information may be obtained by the UE by at least one of:
determining the second indication information based on a protocol convention; or
obtaining second indication information indicated by the network-side device.

In an embodiment of the present disclosure, the second indication information may be indicated by the network-side device by at least one of:
indicating the second indication information to the UE through a security mode command; or
indicating the second indication information to the UE through other dedicated signalling other than the security mode command. The other dedicated signalling may include for example RRC reconfiguration information and/or DL information transfer information.

At step 403a, calculation is executed on to-be-verified system information with the first verification algorithm to obtain a second value.

At step 404a, the second value is sent to the network-side device, such that the network-side device executes the correctness verification for system information based on the second value.

In an embodiment of the present disclosure, the second value may be sent by the UE to the network-side device by at least one of:
sending the second value to the network-side device through the security mode command; or
sending the second value to the network-side device through other dedicated signalling other than the security mode command. The other dedicated signalling may include for example, RRC reconfiguration complete information and/or DL information transfer information.

Further, in an embodiment of the present disclosure, the network-side device may execute the correctness verification for system information based on the second value by: executing, by the network-side device, calculation on the to-be-verified system information based on the first verification algorithm to obtain a first value, determining whether the first value matches the second value, when the first value matches the second value, determining the verification result as verification success, and when the first value does not match the second value, determining the verification result as verification failure. A method of the network-side device determining the first verification algorithm may refer to the description of in the above embodiments, which will not be repeated here in the embodiment of the present disclosure.

To sum up, in the system information verification method provided by the embodiment of the present disclosure, the UE sends auxiliary information to the network-side device, obtains information that is sent by the network-side device based on the auxiliary information, and triggers correctness verification for system information based on information sent by the network-side device. The auxiliary information includes at least one of: a verification manner supported by the UE, information of a verification algorithm supported by the UE, an identifier of system information expected to be verified by the UE, an identifier of system information received by the UE, an identifier of system information of interest of the UE, or first indication information indicating that the UE expects system information verification. Therefore, in the embodiment of the present disclosure, the UE first reports the verification algorithm supported by the UE to the network-side device, such that the network-side device may determine, based on the verification algorithm supported by the UE, a verification algorithm used in a subsequent correctness verification for system information, and indicate the verification algorithm to the UE. Therefore, when the correctness verification for system information is executed subsequently, it may be ensured that the network-side device and the UE use a same verification algorithm, which improves the accuracy of the system information verification.

FIG. 4b is a schematic flowchart of a system information verification method provided by an embodiment of the present disclosure. The method is executed by the UE, and a verification manner in this embodiment includes executing the correctness verification for system information by the network-side device. As shown in FIG. 4b, the system information verification method may include the following steps 401b-405b.

At step 401b, auxiliary information is sent to a network-side device.

At step 402b, information of a first verification algorithm and second indication information are obtained.

At step 403b, calculation is executed on to-be-verified system information with the first verification algorithm to obtain a second value.

At step 404b, the second value is sent to the network-side device, such that the network-side device executes the correctness verification for system information based on the second value.

The related description of the steps 401b-404b may refer to the description of the above embodiments, which will not be repeated here in the embodiment of the present disclosure.

At step 405b, verification result information sent by the network-side device is obtained.

In an embodiment of the present disclosure, the verification result information may include at least one of:
a verification result of executing the correctness verification for system information; where the verification result indicates verification success or verification failure;
an area identifier of system information which undergoes the correctness verification;
third indication information indicating whether the system information is subjected to a security problem; or
fourth indication information including a type indication of the security problem subjected by the system information; where the type indication includes an indication indicating system information correctness verification failure and/or an indication indicating system information tampered.

In an embodiment of the present disclosure, the above area identifier of the system information which undergoes the correctness verification may include at least one of:
a cell identifier of the system information which undergoes the correctness verification;
a cell type identifier of the system information which undergoes the correctness verification;
a cell group type identifier of the system information which undergoes the correctness verification;
a tracking area identifier of the system information that undergoes the correctness verification; or
an access network notification area identifier of the system information, which undergoes the correctness verification.

The exemplary description of the cell identifier, the cell type identifier, the cell group type identifier, the tracking area identifier, and the access network notification area identifier may refer to the above embodiments, which will not be repeated here in the embodiment of the present disclosure.

In addition, it should be noted that in an embodiment of the present disclosure, after the network-side device executes the correctness verification for system information based on the second value, the network-side device may further determine whether the system information is subjected to a security problem.

Specifically, in an embodiment of the present disclosure, the network-side device may determine whether the system information is subjected to a security problem by at least one of the following.

In a first method, it is determined whether the system information is subjected to a security problem based on the verification result.

In an embodiment of the present disclosure, the network-side device determines whether the system information is subjected to a security problem based on the verification result mainly by: determining the number of verification failures for the system information; in response to that the number of verification failures exceeds a first threshold (for example, the first threshold may be a positive integer), determining that the system information is subjected to a security problem; and, in response to that the number of verification failures does not exceed the first threshold, determining that the system information is not subjected to a security problem. In an embodiment of the present disclosure, the first threshold may be indicated by a base station. In another embodiment of the present disclosure, the first threshold may also be determined by the UE based on a protocol convention. In addition, in an embodiment of the present disclosure, the number of verification failures may be the number of verification failures for same system information. Further, in an embodiment of the present disclosure, the number of verification failures may be the number of continuous verification failures for the same system information.

Exemplarily, in an embodiment of the present disclosure, it is assumed that the first threshold is 5, and the network-side device first determines continuously the verification failure of SIB3 for 2 times, then determines continuously the verification failure of SIB2 for 3 times, and finally determines continuously the verification failure of the SIB3 for 3 times again. Although the verification failure of the SIB3 is determined for 5 times, because the number of verification failures 5 of the verification failure of the SIB3 is not continuous, the network-side device determines that the SIB3 is not subjected to “the system information security problem”.

In a second method, it is determined whether the system information is subjected to a security problem based on the number of times of the network-side device sending system information.

In an embodiment of the present disclosure, the network-side device may determine whether the system information is subjected to a security problem based on the number of times of the network-side device sending system information by: determining the number of times of sending the system information; in response to that the number of times of sending system information exceeds a second threshold (for example, the second threshold may be a positive integer), determining that the system information is subjected to a security problem; and, in response to that the number of times of sending does not exceed the second threshold, determining that the system information is not subjected to a security problem. In an embodiment of the present disclosure, the second threshold may be indicated by the base station. In another embodiment of the present disclosure, the second threshold may also be determined by the UE based on a protocol convention. In addition, in an embodiment of the present disclosure, the number of times of sending may be the number of times of sending same system information. Further, in an embodiment of the present disclosure, the number of times of sending may be the number of times of continuously sending the same system information.

It should be noted that, in an embodiment of the present disclosure, when the verification result for the system information is determined as verification failure, the network-side device re-sends the system information to the UE, such that the number of verification failures for the system information may be determined by counting the number of times of the network-side device continuously sending the same system information, and then whether the system information is subjected to a security problem may be determined.

Exemplarily, in an embodiment of the present disclosure, it is assumed that the first threshold is 5, and the network-side device first continuously sends the SIB3 for 2 times, then continuously sends the SIB2 for 3 times, and finally continuously sends the SIB3 for 3 times again. Although the network-side device sends the SIB3 for 5 times, because the number of times 5 of sending the SIB3 is not continuous, the network-side device determines that the SIB3 is not subjected to “the system information security problem”.

Further, in an embodiment of the present disclosure, after determining whether the system information is not subjected to a security problem, the network-side device may further use the above third indication information to indicate a result of determining “whether the system information is subjected to a security problem”. In an embodiment of the present disclosure, the third indication information may be of N bits, where N is a positive integer. Exemplarily, in an embodiment of the present disclosure, the third indication information may be of 1 bit, and when content included in 1 bit is “0”, it indicates that the system information is not subjected to a security problem; and when content included in 1 bit is “1”, it indicates that the system information is subjected to a security problem.

To sum up, in the system information verification method provided by the embodiment of the present disclosure, the UE sends auxiliary information to the network-side device, obtains information that is sent by the network-side device based on the auxiliary information, and triggers correctness verification for system information based on information sent by the network-side device. The auxiliary information includes at least one of: a verification manner supported by the UE, information of a verification algorithm supported by the UE, an identifier of system information expected to be verified by the UE, an identifier of system information received by the UE, an identifier of system information of interest of the UE, or first indication information indicating that the UE expects system information verification. Therefore, in the embodiment of the present disclosure, the UE first reports the verification algorithm supported by the UE to the network-side device, such that the network-side device may determine, based on the verification algorithm supported by the UE, a verification algorithm used in a subsequent correctness verification for system information, and indicate the verification algorithm to the UE. Therefore, when the correctness verification for system information is executed subsequently, it may be ensured that the network-side device and the UE use a same verification algorithm, which improves the accuracy of the system information verification.

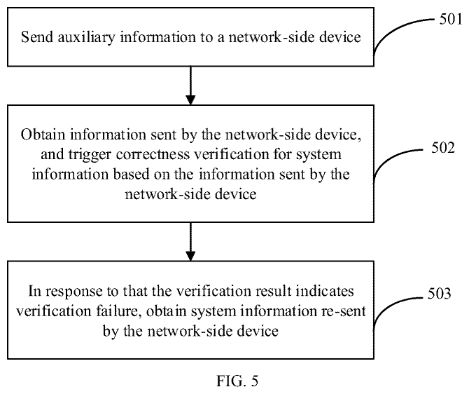

FIG. 5 is a schematic flowchart of a system information verification method provided by an embodiment of the present disclosure. The method is executed by UE. As shown in FIG. 5, the system information verification method may include the following steps 501-503.

At step 501, auxiliary information is sent to a network-side device.

In an embodiment of the present disclosure, the auxiliary information includes at least one of: a verification manner supported by the UE, information of a verification algorithm supported by the UE, an identifier of system information expected to be verified by the UE, an identifier of system information received by the UE, an identifier of system information of interest of the UE, or first indication information indicating that the UE expects system information verification.

At step 502, information sent by a network-side device is obtained, and correctness verification for system information is triggered based on information sent by the network-side device.

In addition, in an embodiment of the present disclosure, the steps 501-502 may be steps in the above steps 301-305. In another embodiment of the present disclosure, the steps 501-502 may be steps in the above steps 401a-404b. In another embodiment of the present disclosure, the steps 501-502 may be steps in the above steps 401a-405b. In addition, the related description of the steps 501-502 may refer to the description of the above embodiments, which will not be repeated here in the embodiment of the present disclosure.

At step 503, in response to that the verification result indicates verification failure, system information re-sent by the network-side device is obtained.

In an embodiment of the present disclosure, when the verification result indicates verification failure, it indicates that the system information which undergoes the correctness verification is not successfully transmitted, and at this time, the network-side device needs to re-send the system information once.

To sum up, in the system information verification method provided by the embodiment of the present disclosure, the UE sends auxiliary information to the network-side device, obtains information that is sent by the network-side device based on the auxiliary information, and triggers correctness verification for system information based on information sent by the network-side device. The auxiliary information includes at least one of: a verification manner supported by the UE, information of a verification algorithm supported by the UE, an identifier of system information expected to be verified by the UE, an identifier of system information received by the UE, an identifier of system information of interest of the UE, or first indication information indicating that the UE expects system information verification. Therefore, in the embodiment of the present disclosure, the UE first reports the verification algorithm supported by the UE to the network-side device, such that the network-side device may determine, based on the verification algorithm supported by the UE, a verification algorithm used in a subsequent correctness verification for system information, and indicate the verification algorithm to the UE. Therefore, when the correctness verification for system information is executed subsequently, it may be ensured that the network-side device and the UE use a same verification algorithm, which improves the accuracy of the system information verification.

FIG. 6 is a schematic flowchart of a system information verification method provided by an embodiment of the present disclosure. The method is executed by UE. As shown in FIG. 6, the system information verification method may include the following steps 601-605.

At step 601, auxiliary information is sent to a network-side device.

In an embodiment of the present disclosure, the auxiliary information may include at least one of: a verification manner supported by the UE, information of a verification algorithm supported by the UE, an identifier of system information expected to be verified by the UE, an identifier of system information received by the UE, an identifier of system information of interest of the UE, or first indication information indicating that the UE expects system information verification.

At step 602, information sent by a network-side device is obtained, and correctness verification for system information is triggered based on information sent by the network-side device.

At step 603, in response to that the verification result indicates verification failure, system information re-sent by the network-side device is obtained.

The detailed description of the steps 601-603 may refer to the description of the above embodiments, which will not be repeated here in the embodiment of the present disclosure.

At step 604, it is determined whether the system information is subjected to a security problem.

In an embodiment of the present disclosure, the UE determines whether the system information is subjected to a security problem by at least one of the following.

In a first method, it is determined whether the system information is subjected to a security problem based on the verification result.

In an embodiment of the present disclosure, the UE determines whether the system information is subjected to a security problem based on the verification result mainly by: determining the number of verification failures for the system information; in response to that the number of verification failures exceeds a first threshold (for example, the first threshold may be a positive integer), determining that the system information is subjected to a security problem; and, in response to that the number of verification failures does not exceed the first threshold, determining that the system information is not subjected to a security problem. In an embodiment of the present disclosure, the first threshold may be indicated by a base station. In another embodiment of the present disclosure, the first threshold may also be determined by the UE based on a protocol convention. In addition, in an embodiment of the present disclosure, the number of verification failures may be the number of verification failures for same system information. Further, in an embodiment of the present disclosure, the number of verification failures may be the number of continuous verification failures for the same system information.

Exemplarily, in an embodiment of the present disclosure, it is assumed that the first threshold is 5, and the UE first determines continuously the verification failure of SIB3 for 2 times, then determines continuously the verification failure of SIB2 for 3 times, and finally determines continuously the verification failure of the SIB3 for 3 times again. Although the verification failure of the SIB3 is determined for 5 times, because the number of verification failures 5 of the verification failure of the SIB3 is not continuous, the UE determines that the SIB3 is not subjected to “the system information security problem”.

In a second method, it is determined whether the system information is subjected to a security problem based on the number of times of the UE receiving system information.

In an embodiment of the present disclosure, the UE may determine whether the system information is subjected to a security problem based on the number of times of the UE receiving the system information by: determining the number of times of receiving system information; in response to that the number of times of receiving system information exceeds a second threshold (for example, the second threshold may be a positive integer), determining that the system information is subjected to a security problem; and, in response to that the number of times of receiving does not exceed the second threshold, determining that the system information is not subjected to a security problem. In an embodiment of the present disclosure, the second threshold may be indicated by the base station. In another embodiment of the present disclosure, the second threshold may also be determined by the UE based on a protocol convention. In addition, in an embodiment of the present disclosure, the number of times of receiving may be the number of times of receiving same system information. Further, in an embodiment of the present disclosure, the number of times of receiving may be the number of times of continuously receiving the same system information.

It should be noted that, in an embodiment of the present disclosure, when the verification result for the system information is determined as verification failure, the network-side device re-sends the system information to the UE, such that the number of verification failures for the system information may be determined by counting the number of times of the UE continuously receiving the same system information, and then whether the system information is subjected to a security problem may be determined.

Exemplarily, in an embodiment of the present disclosure, it is assumed that the first threshold is 5, and the UE first continuously receives the SIB3 for 2 times, then continuously receives the SIB2 for 3 times, and finally continuously receives the SIB3 for 3 times again. Although the UE receives the SIB3 for 5 times, because the number of times 5 of receiving the SIB3 is not continuous, the UE determines that the SIB3 is not subjected to “the system information security problem”.

In addition, it should be noted that, in the above step 602, even if the UE receives the verification result information sent by the network-side device when the UE triggers the correctness verification for system information based on information sent by the network-side device, and the verification result information includes the third indication information and/or the fourth indication information (that is, corresponding to the embodiment in FIG. 4b), the UE still executes the step of “determining whether the system information is subjected to a security problem” in the step 604. That is, in an embodiment of the present disclosure, the step of determining, the network-side device, whether the system information is subjected to a security problem and the step of determining, the UE, whether the system information is subjected to a security problem are independent of each other.

At step 605, in response to determining that the system information is subjected to a security problem, the UE executes a corresponding operation.

In an embodiment of the present disclosure, in response to determining that the system information is subjected to a security problem, the corresponding operation executed by the UE may include at least one of the following.

In a first operation, in response to determining that the system information is subjected to a security problem, a connection release is triggered to execute cell selection or re-selection.

In an embodiment of the present disclosure, triggering the connection release may include:
sending the fifth indication information and/or a connection release indication to the network-side device.

In an embodiment of the present disclosure, the fifth indication information is to indicate a specific situation of the system information being subjected to a security problem, and the fifth indication information may include at least one of:
an identifier of the system information being subjected to a security problem;
fourth indication information including a type indication of the security problem subjected by the system information, where the type indication includes an indication indicating system information correctness verification failure and/or an indication indicating system information tampered; or an area identifier of the system information being subjected to a security problem.

In addition, in an embodiment of the present disclosure, the above area identifier of the system information being subjected to a security problem may include at least one of:
a cell identifier of the system information being subjected to a security problem;
a cell type identifier of the system information being subjected to a security problem;
a cell group type identifier of the system information being subjected to a security problem;
a tracking area identifier of the system information being subjected to a security problem; or
an access network notification area identifier of the system information being subjected to a security problem.

The exemplary description of the cell identifier, the cell type identifier, the cell group type identifier, the tracking area identifier, and the access network notification area identifier may refer to the description of the above embodiments, which will not be repeated here in the embodiment of the present disclosure.

Further, in an embodiment of the present disclosure, the cell re-selection may be executed by the UE by at least one of the following.

A selection priority of a cell or a frequency point in which the system information is subjected to a security problem is reduced. For example, the selection priority of “the cell or the frequency point in which the system information is subjected to a security problem” may be configured to be lowest.

The cell or the frequency point in which the system information is subjected to a security problem is ignored. For example, “the cell or the frequency point in which the system information is subjected to a security problem” may not be determined as a candidate cell or frequency point.

In a second operation, in response to determining that the system information is subjected to a security problem, a connection reconstruction is triggered to execute the cell selection or re-selection.

In an embodiment of the present disclosure, triggering the connection reconstruction may include:
sending the fifth indication information and/or a connection reconstruction request message to the network-side device.

In an embodiment of the present disclosure, the fifth indication information may be sent by the UE to the network-side device by the following.

The UE first sends sixth indication information to the network-side device by a connection reconstruction request message. The sixth indication information is to indicate that the system information of the UE is currently subjected to a security problem. The sixth indication information may be of N bits, where N is a positive integer. For example, the sixth indication information may be of 1 bit, and when content included in 1 bit is 1, the sixth indication information indicates that the system information of the UE is currently subjected to a security problem. Then, after the UE reconstructs a connection, the network-side device may send, to the UE, a request message to request the above fifth indication information, and the UE may send the fifth indication information to the network-side device based on the request message sent by the network-side device.

In a third operation, in response to determining that the system information is subjected to a security problem, the fifth indication information is reported to the network-side device.

To sum up, in the system information verification method provided by the embodiment of the present disclosure, the UE sends auxiliary information to the network-side device, obtains information that is sent by the network-side device based on the auxiliary information, and triggers correctness verification for system information based on information sent by the network-side device. The auxiliary information includes at least one of: a verification manner supported by the UE, information of a verification algorithm supported by the UE, an identifier of system information expected to be verified by the UE, an identifier of system information received by the UE, an identifier of system information of interest of the UE, or first indication information indicating that the UE expects system information verification. Therefore, in the embodiment of the present disclosure, the UE first reports the verification algorithm supported by the UE to the network-side device, such that the network-side device may determine, based on the verification algorithm supported by the UE, a verification algorithm used in a subsequent correctness verification for system information, and indicate the verification algorithm to the UE. Therefore, when the correctness verification for system information is executed subsequently, it may be ensured that the network-side device and the UE use a same verification algorithm, which improves the accuracy of the system information verification.

In addition, in the embodiments of the present disclosure, after the correctness verification is executed for the system information, whether the system information is subjected to a security problem is further determined, and when the system information is subjected to a security problem, the UE executes the corresponding operation (that is, triggering the connection release, and/or triggering the connection reconstruction, and/or reporting the fifth indication information to the network-side device), which thereby may achieve the purpose of “executing the differentiated control on the UE for which the system information verification fails according to different security requirements of the UE.”

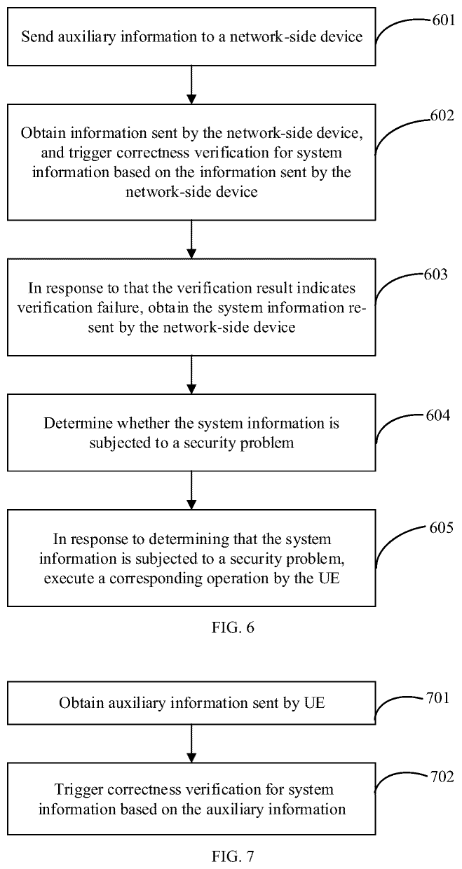

FIG. 7 is a schematic flowchart of a system information verification method provided by an embodiment of the present disclosure. The method is executed by a network-side device. As shown in FIG. 7, the system information verification method may include the following steps 701-702.

At step 701, auxiliary information sent by UE is obtained.

In an embodiment of the present disclosure, the auxiliary information may include at least one of: a verification manner supported by the UE, information of a verification algorithm supported by the UE, an identifier of system information expected to be verified by the UE, an identifier of system information received by the UE, an identifier of system information of interest of the UE, or first indication information indicating that the UE expects system information verification.

At step 702, correctness verification for system information is triggered based on the auxiliary information.

The detailed description of the steps 701-702 may refer to the description of the above embodiments, which will not be repeated here in the embodiment of the present disclosure.

To sum up, in the system information verification method provided by the embodiment of the present disclosure, the UE sends auxiliary information to the network-side device, obtains information that is sent by the network-side device based on the auxiliary information, and triggers correctness verification for system information based on information sent by the network-side device. The auxiliary information includes at least one of: a verification manner supported by the UE, information of a verification algorithm supported by the UE, an identifier of system information expected to be verified by the UE, an identifier of system information received by the UE, an identifier of system information of interest of the UE, or first indication information indicating that the UE expects system information verification. Therefore, in the embodiment of the present disclosure, the UE first reports the verification algorithm supported by the UE to the network-side device, such that the network-side device may determine, based on the verification algorithm supported by the UE, a verification algorithm used in a subsequent correctness verification for system information, and indicate the verification algorithm to the UE. Therefore, when the correctness verification for system information is executed subsequently, it may be ensured that the network-side device and the UE use a same verification algorithm, which improves the accuracy of the system information verification.

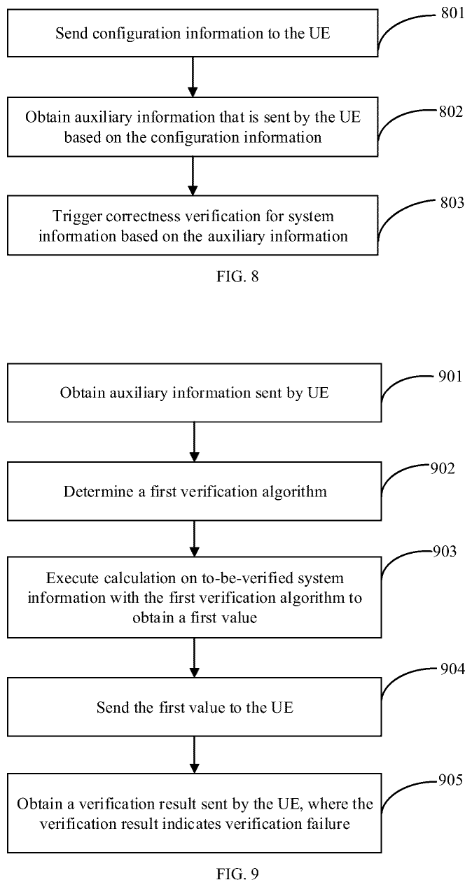

FIG. 8 is a schematic flowchart of a system information verification method provided by an embodiment of the present disclosure. The method is executed by a network-side device. As shown in FIG. 8, the system information verification method may include the following steps 801-803.

At step 801, configuration information is sent to the UE.

At step 802, auxiliary information that is sent by the UE based on the configuration information is obtained.

At step 803, correctness verification for system information is triggered based on the auxiliary information.

The related description of the steps 801-802 may refer to the description of the above embodiments, which will not be repeated here in the embodiment of the present disclosure.

To sum up, in the system information verification method provided by the embodiment of the present disclosure, the UE sends auxiliary information to the network-side device, obtains information that is sent by the network-side device based on the auxiliary information, and triggers correctness verification for system information based on information sent by the network-side device. The auxiliary information includes at least one of: a verification manner supported by the UE, information of a verification algorithm supported by the UE, an identifier of system information expected to be verified by the UE, an identifier of system information received by the UE, an identifier of system information of interest of the UE, or first indication information indicating that the UE expects system information verification. Therefore, in the embodiment of the present disclosure, the UE first reports the verification algorithm supported by the UE to the network-side device, such that the network-side device may determine, based on the verification algorithm supported by the UE, a verification algorithm used in a subsequent correctness verification for system information, and indicate the verification algorithm to the UE. Therefore, when the correctness verification for system information is executed subsequently, it may be ensured that the network-side device and the UE use a same verification algorithm, which improves the accuracy of the system information verification.

FIG. 9 is a schematic flowchart of a system information verification method provided by an embodiment of the present disclosure. The method is executed by a network-side device. As shown in FIG. 9, the system information verification method may include the following steps 901-905.

At step 901, auxiliary information sent by UE is obtained.

At step 902, a first verification algorithm is determined. The first verification algorithm is any one of verification algorithms supported by the UE.

At step 903, calculation is executed on to-be-verified system information with the first verification algorithm to obtain a first value.

At step 904, the first value is sent to the UE.

In an embodiment of the present disclosure, when sending the first value to the UE, the network-side device may send the information of the first verification algorithm to the UE, such that the UE may determine the first verification algorithm based on the information of the first verification algorithm, execute calculation on the to-be-verified system information based on the first verification algorithm to obtain the second value, and verify the to-be-verified system information by matching the first value and the second value.

Further, in an embodiment of the present disclosure, the network-side device may also not send the information of the first verification algorithm to the UE, and in this case, the UE may directly determine the information of the first verification algorithm based on the protocol convention.

At step 905, a verification result sent by the UE is obtained, where the verification result indicates verification failure.

The related description of the steps 901-905 may refer to the description of the above embodiments, which will not be repeated here in the embodiment of the present disclosure.

To sum up, in the system information verification method provided by the embodiment of the present disclosure, the UE sends auxiliary information to the network-side device, obtains information that is sent by the network-side device based on the auxiliary information, and triggers correctness verification for system information based on information sent by the network-side device. The auxiliary information includes at least one of: a verification manner supported by the UE, information of a verification algorithm supported by the UE, an identifier of system information expected to be verified by the UE, an identifier of system information received by the UE, an identifier of system information of interest of the UE, or first indication information indicating that the UE expects system information verification. Therefore, in the embodiment of the present disclosure, the UE first reports the verification algorithm supported by the UE to the network-side device, such that the network-side device may determine, based on the verification algorithm supported by the UE, a verification algorithm used in a subsequent correctness verification for system information, and indicate the verification algorithm to the UE. Therefore, when the correctness verification for system information is executed subsequently, it may be ensured that the network-side device and the UE use a same verification algorithm, which improves the accuracy of the system information verification.

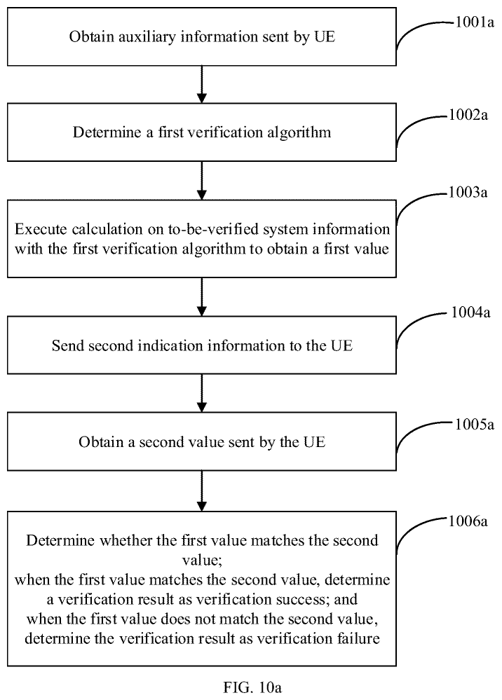

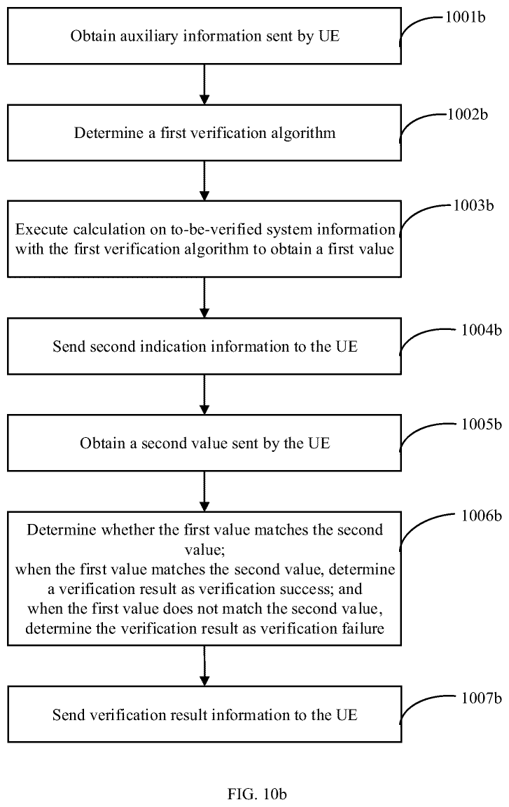

FIG. 10a is a schematic flowchart of a system information verification method provided by an embodiment of the present disclosure. The method is executed by a network-side device. As shown in FIG. 10a, the system information verification method may include the following steps 1001a-1006a.

At step 1001a, auxiliary information sent by UE is obtained.

At step 1002a, a first verification algorithm is determined. The first verification algorithm is any one of verification algorithms supported by the UE.

At step 1003a, calculation is executed on to-be-verified system information with the first verification algorithm to obtain a first value.

At step 1004a, second indication information is sent to the UE. The second indication information is to instruct the UE to execute the correctness verification for system information.

In an embodiment of the present disclosure, when sending the second indication information to the UE, the network-side device may send the information of the first verification algorithm to the UE, such that the UE may determine the first verification algorithm based on the information of the first verification algorithm, execute calculation on the to-be-verified system information based on the first verification algorithm to obtain the second value, and verify the to-be-verified system information by matching the first value and the second value.

Further, in an embodiment of the present disclosure, the network-side device may also not send the information of the first verification algorithm to the UE, and in this case, the UE may directly determine the information of the first verification algorithm based on the protocol convention.

At step 1005a, a second value sent by the UE is obtained.

At step 1006a, whether the first value matches the second value is determined; when the first value matches the second value, the verification result is determined as verification success; and when the first value does not match the second value, the verification result is determined as verification failure.

The related description of the steps 1001a-1006a may refer to the description of the above embodiments, which will not be repeated here in the embodiment of the present disclosure.

To sum up, in the system information verification method provided by the embodiment of the present disclosure, the UE sends auxiliary information to the network-side device, obtains information that is sent by the network-side device based on the auxiliary information, and triggers correctness verification for system information based on information sent by the network-side device. The auxiliary information includes at least one of: a verification manner supported by the UE, information of a verification algorithm supported by the UE, an identifier of system information expected to be verified by the UE, an identifier of system information received by the UE, an identifier of system information of interest of the UE, or first indication information indicating that the UE expects system information verification. Therefore, in the embodiment of the present disclosure, the UE first reports the verification algorithm supported by the UE to the network-side device, such that the network-side device may determine, based on the verification algorithm supported by the UE, a verification algorithm used in a subsequent correctness verification for system information, and indicate the verification algorithm to the UE. Therefore, when the correctness verification for system information is executed subsequently, it may be ensured that the network-side device and the UE use a same verification algorithm, which improves the accuracy of the system information verification.

FIG. 10b is a schematic flowchart of a system information verification method provided by an embodiment of the present disclosure. The method is executed by a network-side device. As shown in FIG. 10b, the system information verification method may include the following steps 1001b-1007b.

At step 1001b, auxiliary information sent by UE is obtained.

At step 1002b, a first verification algorithm is determined. The first verification algorithm is any one of verification algorithms supported by the UE.

At step 1003b, calculation is executed on to-be-verified system information with the first verification algorithm to obtain a first value.

At step 1004b, second indication information is sent to the UE. The second indication information is to instruct the UE to execute the correctness verification for system information.

At step 1005b, a second value sent by the UE is obtained.

At step 1006b, whether the first value matches the second value is determined; when the first value matches the second value, the verification result is determined as verification success; and when the first value does not match the second value, the verification result is determined as verification failure.

At step 1007b, verification result information is sent to the UE.

The related description of the steps 1001b-1007b may refer to the description of the above embodiments, which will not be repeated here in the embodiment of the present disclosure.

To sum up, in the system information verification method provided by the embodiment of the present disclosure, the UE sends auxiliary information to the network-side device, obtains information that is sent by the network-side device based on the auxiliary information, and triggers correctness verification for system information based on information sent by the network-side device. The auxiliary information includes at least one of: a verification manner supported by the UE, information of a verification algorithm supported by the UE, an identifier of system information expected to be verified by the UE, an identifier of system information received by the UE, an identifier of system information of interest of the UE, or first indication information indicating that the UE expects system information verification. Therefore, in the embodiment of the present disclosure, the UE first reports the verification algorithm supported by the UE to the network-side device, such that the network-side device may determine, based on the verification algorithm supported by the UE, a verification algorithm used in a subsequent correctness verification for system information, and indicate the verification algorithm to the UE. Therefore, when the correctness verification for system information is executed subsequently, it may be ensured that the network-side device and the UE use a same verification algorithm, which improves the accuracy of the system information verification.

FIG. 11 is a schematic flowchart of a system information verification method provided by an embodiment of the present disclosure. The method is executed by a network-side device. As shown in FIG. 11, the system information verification method may include the following steps 1101-1103.

At step 1101, auxiliary information sent by UE is obtained.

At step 1102, correctness verification for system information is triggered based on the auxiliary information.

In an embodiment of the present disclosure, the above steps 1101-1102 may be the steps 901-905 in the above embodiment. In another embodiment of the present disclosure, the above steps 1101-1102 may be the steps 1001a-1006a in the above embodiment. In yet another embodiment of the present disclosure, the above steps 1101-1102 may be the steps 1001b-1007b in the above embodiment.

At step 1103, in response to that the verification result indicates verification failure, the system information is re-sent to the UE.

To sum up, in the system information verification method provided by the embodiment of the present disclosure, the UE sends auxiliary information to the network-side device, obtains information that is sent by the network-side device based on the auxiliary information, and triggers correctness verification for system information based on information sent by the network-side device. The auxiliary information includes at least one of: a verification manner supported by the UE, information of a verification algorithm supported by the UE, an identifier of system information expected to be verified by the UE, an identifier of system information received by the UE, an identifier of system information of interest of the UE, or first indication information indicating that the UE expects system information verification. Therefore, in the embodiment of the present disclosure, the UE first reports the verification algorithm supported by the UE to the network-side device, such that the network-side device may determine, based on the verification algorithm supported by the UE, a verification algorithm used in a subsequent correctness verification for system information, and indicate the verification algorithm to the UE. Therefore, when the correctness verification for system information is executed subsequently, it may be ensured that the network-side device and the UE use a same verification algorithm, which improves the accuracy of the system information verification.

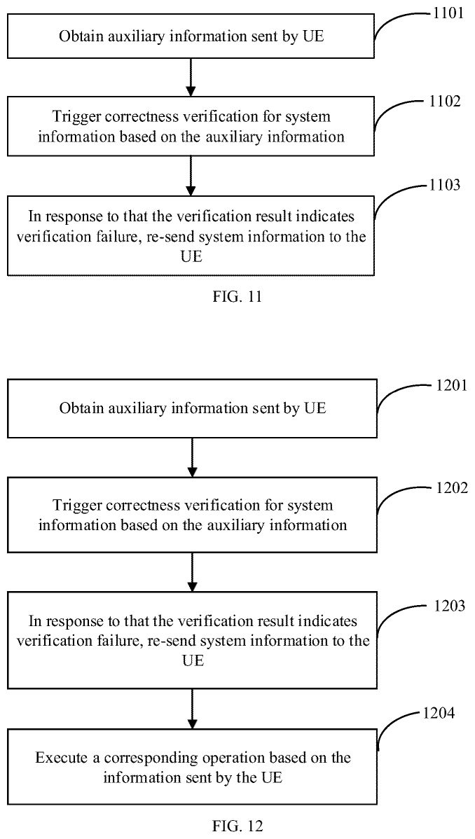

FIG. 12 is a schematic flowchart of a system information verification method provided by an embodiment of the present disclosure. The method is executed by a network-side device. As shown in FIG. 12, the system information verification method may include the following steps 1201-1204.

At step 1201, auxiliary information sent by UE is obtained.

At step 1202, correctness verification for system information is triggered based on the auxiliary information.

At step 1203, in response to that the verification result indicates verification failure, the system information is re-sent to the UE.

The related description of the steps 1201-1203 may refer to the description of the above embodiments, which will not be repeated here in the embodiment of the present disclosure.

At step 1204, a corresponding operation is executed based on the information sent by the UE.

In an embodiment of the present disclosure, the corresponding operation may be executed by at least one of:
entering a connection release, to execute cell selection or re-selection;
entering a connection reconstruction, to execute the cell selection or re-selection; or
obtaining fifth indication information sent by the UE, where the fifth indication information is to indicate that the system information is subjected to a security problem.

In an embodiment of the present disclosure, entering the connection release may include:

receiving the fifth indication information and/or a connection release indication sent by the UE.

In an embodiment of the present disclosure, entering the connection reconstruction may include:

receiving the fifth indication information and/or a connection reconstruction request message sent by the UE.

In an embodiment of the present disclosure, the cell re-selection is executed by at least one of:
reducing a selection priority of a cell or a frequency point in which the system information is subjected to a security problem; or
ignoring the cell or the frequency point in which the system information is subjected to a security problem.

In an embodiment of the present disclosure, the fifth indication information includes at least one of:
an identifier of the system information being subjected to a security problem;
fourth indication information including a type indication of the security problem subjected by the system information, where the type indication includes an indication indicating system information correctness verification failure and/or an indication indicating system information tampered; or
an area identifier of the system information being subjected to a security problem.

In an embodiment of the present disclosure, the area identifier of the system information being subjected to a security problem includes at least one of:
a cell identifier of the system information being subjected to a security problem;
a cell type identifier of the system information being subjected to a security problem;
a cell group type identifier of the system information being subjected to a security problem;
a tracking area identifier of the system information being subjected to a security problem; or
an access network notification area identifier of the system information being subjected to a security problem.

Other descriptions of the step 1204 may refer to the description of the above embodiments, which will not be repeated here in the embodiment of the present disclosure.

To sum up, in the system information verification method provided by the embodiment of the present disclosure, the UE sends auxiliary information to the network-side device, obtains information that is sent by the network-side device based on the auxiliary information, and triggers correctness verification for system information based on information sent by the network-side device. The auxiliary information includes at least one of: a verification manner supported by the UE, information of a verification algorithm supported by the UE, an identifier of system information expected to be verified by the UE, an identifier of system information received by the UE, an identifier of system information of interest of the UE, or first indication information indicating that the UE expects system information verification. Therefore, in the embodiment of the present disclosure, the UE first reports the verification algorithm supported by the UE to the network-side device, such that the network-side device may determine, based on the verification algorithm supported by the UE, a verification algorithm used in a subsequent correctness verification for system information, and indicate the verification algorithm to the UE. Therefore, when the correctness verification for system information is executed subsequently, it may be ensured that the network-side device and the UE use a same verification algorithm, which improves the accuracy of the system information verification.

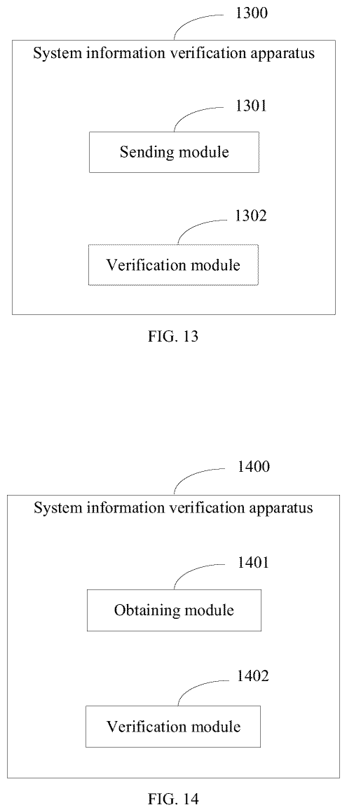

FIG. 13 is a schematic structural diagram of a system information verification apparatus provided by an embodiment of the present disclosure. The apparatus is applied to UE. As shown in FIG. 13, the system information verification apparatus 1300 may include:
a sending module 1301, configured to send auxiliary information to a network-side device; where the auxiliary information includes at least one of: a verification manner supported by the UE, information of a verification algorithm supported by the UE, an identifier of system information expected to be verified by the UE, an identifier of system information received by the UE, an identifier of system information of interest of the UE, or first indication information indicating that the UE expects system information verification; and
a verification module 1302, configured to trigger correctness verification for system information based on information sent by the network-side device.

To sum up, in the system information verification apparatus provided by the embodiment of the present disclosure, the UE sends auxiliary information to the network-side device, obtains information that is sent by the network-side device based on the auxiliary information, and triggers correctness verification for system information based on information sent by the network-side device. The auxiliary information includes at least one of: a verification manner supported by the UE, information of a verification algorithm supported by the UE, an identifier of system information expected to be verified by the UE, an identifier of system information received by the UE, an identifier of system information of interest of the UE, or first indication information indicating that the UE expects system information verification. Therefore, in the embodiment of the present disclosure, the UE first reports the verification algorithm supported by the UE to the network-side device, such that the network-side device may determine, based on the verification algorithm supported by the UE, a verification algorithm used in a subsequent correctness verification for system information, and indicate the verification algorithm to the UE. Therefore, when the correctness verification for system information is executed subsequently, it may be ensured that the network-side device and the UE use a same verification algorithm, which improves the accuracy of the system information verification.

Optionally, in an embodiment of the present disclosure, the apparatus is further configured to:
obtain configuration information sent by the network-side device; where the configuration information includes at least one of:
a verification manner supported by the network-side device;
an area identifier of system information supporting verification;
a first request message for requesting the UE to report whether the UE is capable of supporting system information verification, and/or the information of the verification algorithm supported by the UE;
a second request message for requesting the UE to report the identifier of the system information expected to be verified by the UE;
a third request message for requesting the UE to report the identifier of the system information received by the UE; or
a fourth request message for requesting the UE to report the identifier of the system information of interest of the UE.

Optionally, in an embodiment of the present disclosure, the sending module is configured to:
send the auxiliary information to the network-side device based on the configuration information.

Optionally, in an embodiment of the present disclosure, the verification manner includes at least one of:
executing, by the UE, the correctness verification for system information; or
executing, by the network-side device, the correctness verification for system information.

Optionally, in an embodiment of the present disclosure, the information of the verification algorithm supported by the UE includes at least one of:
an algorithm type identifier of the verification algorithm supported by the UE; or an algorithm identifier of the verification algorithm supported by the UE.

Optionally, in an embodiment of the present disclosure, the area identifier of the system information supporting verification includes at least one of:
a cell identifier of the system information supporting verification;
a cell type identifier of the system information supporting verification;
a cell group type identifier of the system information supporting verification;
a tracking area identifier of the system information supporting verification; or
an access network notification area identifier of the system information supporting verification.

Optionally, in an embodiment of the present disclosure, the apparatus is further configured to:
obtain the configuration information sent by the network-side device through a broadcast message; or
obtain the configuration information sent by the network-side device through a dedicated configuration message.

Optionally, in an embodiment of the present disclosure, the verification module is further configured to:
obtain a first value and information of a first verification algorithm;
execute calculation on to-be-verified system information with the first verification algorithm to obtain a second value; where the to-be-verified system information includes at least one of: the system information expected to be verified by the UE, the system information received by the UE, or the system information of interest of the UE;
determine whether the first value matches the second value; when the first value matches the second value, determine a verification result as verification success; and when the first value does not match the second value, determine the verification result as verification failure; and
in response to that the verification result indicates verification failure, send the verification result to the network-side device.

Optionally, in an embodiment of the present disclosure, the verification module is further configured to:
obtain information of a first verification algorithm and second indication information;
where the first verification algorithm is selected by the network-side device from verification algorithms supported by the UE, and the second indication information is to instruct the UE to execute the correctness verification for system information;
execute calculation on to-be-verified system information with the first verification algorithm to obtain a second value; where the to-be-verified system information includes at least one of: the system information expected to be verified by the UE, the system information received by the UE, or the system information of interest of the UE; and
send the second value to the network-side device, such that the network-side device executes the correctness verification for system information based on the second value.

Optionally, in an embodiment of the present disclosure, the apparatus is further configured to:
obtain verification result information sent by the network-side device; where the verification result information includes at least one of:
a verification result of executing the correctness verification for system information;
where the verification result indicates verification success or verification failure;
an area identifier of system information which undergoes the correctness verification;
third indication information indicating whether the system information is subjected to a security problem; or
fourth indication information including a type indication of the security problem subjected by the system information, where the type indication includes an indication indicating system information correctness verification failure and/or an indication indicating system information tampered.

Optionally, in an embodiment of the present disclosure, the apparatus is further configured to:
in response to that the verification result indicates verification failure, obtain system information re-sent by the network-side device.

Optionally, in an embodiment of the present disclosure, the apparatus is further configured to:
determine whether the system information is subjected to a security problem.

Optionally, in an embodiment of the present disclosure, the apparatus is further configured to:
determine whether the system information is subjected to a security problem by at least one of:
determining whether the system information is subjected to a security problem based on the verification result; or
determining whether the system information is subjected to a security problem based on the number of times of the UE receiving the system information.

Optionally, in an embodiment of the present disclosure, the apparatus is further configured to:
determine the number of verification failures for the system information, and in response to that the number of verification failures exceeds a first threshold, determine that the system information is subjected to a security problem.

Optionally, in an embodiment of the present disclosure, the number of verification failures indicates the number of verification failures for the same system information.

Optionally, in an embodiment of the present disclosure, the number of verification failures indicates the number of continuous verification failures for the same system information.

Optionally, in an embodiment of the present disclosure, the apparatus is further configured to:
determine the number of times of receiving system information, and in response to that the number of times of receiving system information exceeds a second threshold, determine that the system information is subjected to a security problem.

Optionally, in an embodiment of the present disclosure, the number of times of receiving indicates the number of times of receiving same system information.

Optionally, in an embodiment of the present disclosure, the number of times of receiving indicates the number of times of continuously receiving the same system information.

Optionally, in an embodiment of the present disclosure, the apparatus is further configured to:
in response to determining that the system information is subjected to a security problem, trigger a connection release to execute cell selection or re-selection;
in response to determining that the system information is subjected to a security problem, trigger a connection reconstruction to execute the cell selection or re-selection; or
in response to determining that the system information is subjected to a security problem, report fifth indication information to the network-side device; where the fifth indication information is to indicate a situation of the system information being subjected to a security problem.

Optionally, in an embodiment of the present disclosure, the apparatus is further configured to:
send the fifth indication information and/or a connection release indication to the network-side device.

Optionally, in an embodiment of the present disclosure, the apparatus is further configured to:
send the fifth indication information and/or a connection reconstruction request message to the network-side device.

Optionally, in an embodiment of the present disclosure, the apparatus is further configured to:
reduce a selection priority of a cell or a frequency point in which the system information is subjected to a security problem; and
ignore the cell or the frequency point in which the system information is subjected to a security problem.

Optionally, in an embodiment of the present disclosure, the apparatus is further configured to:
determine the fifth indication information including at least of:
an identifier of the system information being subjected to a security problem;
fourth indication information including a type indication of the security problem subjected by the system information, where the type indication includes an indication indicating system information correctness verification failure and/or an indication indicating system information tampered; or
an area identifier of the system information being subjected to a security problem.

Optionally, in an embodiment of the present disclosure, the apparatus is further configured to:
determine the area identifier of the system information being subjected to a security problem including at least one of:
a cell identifier of the system information being subjected to a security problem;
a cell type identifier of the system information being subjected to a security problem;
a cell group type identifier of the system information being subjected to a security problem;
a tracking area identifier of the system information being subjected to a security problem; or
an access network notification area identifier of the system information being subjected to a security problem.

FIG. 14 is a schematic structural diagram of a system information verification apparatus provided by an embodiment of the present disclosure. The apparatus is applied to a network-side device. As shown in FIG. 14, the system information verification apparatus 1400 may include:
an obtaining module 1401, configured to obtain auxiliary information sent by UE; where the auxiliary information includes at least one of: a verification manner supported by the UE, information of a verification algorithm supported by the UE, an identifier of system information expected to be verified by the UE, an identifier of system information received by the UE, an identifier of system information of interest of the UE, or first indication information indicating that the UE expects system information verification; and
a verification module 1402, configured to trigger correctness verification for system information based on the auxiliary information.

To sum up, in the system information verification apparatus provided by the embodiment of the present disclosure, the UE sends auxiliary information to the network-side device, obtains information that is sent by the network-side device based on the auxiliary information, and triggers correctness verification for system information based on information sent by the network-side device. The auxiliary information includes at least one of: a verification manner supported by the UE, information of a verification algorithm supported by the UE, an identifier of system information expected to be verified by the UE, an identifier of system information received by the UE, an identifier of system information of interest of the UE, or first indication information indicating that the UE expects system information verification. Therefore, in the embodiment of the present disclosure, the UE first reports the verification algorithm supported by the UE to the network-side device, such that the network-side device may determine, based on the verification algorithm supported by the UE, a verification algorithm used in a subsequent correctness verification for system information, and indicate the verification algorithm to the UE. Therefore, when the correctness verification for system information is executed subsequently, it may be ensured that the network-side device and the UE use a same verification algorithm, which improves the accuracy of the system information verification.

Optionally, in an embodiment of the present disclosure, the apparatus is further configured to:
send configuration information to the UE, where the configuration information includes at least one of:
a verification manner supported by the network-side device;
an area identifier of system information supporting verification;
a first request message for requesting the UE to report whether the UE is capable of supporting system information verification, and/or the information of the verification algorithm supported by the UE;
a second request message for requesting the UE to report the identifier of the system information expected to be verified by the UE;
a third request message for requesting the UE to report the identifier of the system information received by the UE; or
a fourth request message for requesting the UE to report the identifier of the system information of interest of the UE.

Optionally, in an embodiment of the present disclosure, the obtaining module is further configured to:
obtain the auxiliary information that is sent by the UE based on the configuration information.

Optionally, in an embodiment of the present disclosure, the verification manner includes at least one of:
verifying, by the UE, the system information; or
verifying, by the network-side device, the system information.

Optionally, in an embodiment of the present disclosure, the information of the verification algorithm supported by the UE includes at least one of:
an algorithm type identifier of the verification algorithm supported by the UE; or
an algorithm identifier of the verification algorithm supported by the UE.

Optionally, in an embodiment of the present disclosure, the area identifier of the system information supporting verification includes at least one of:
a cell identifier of the system information supporting verification;
a cell type identifier of the system information supporting verification;
a cell group type identifier of the system information supporting verification;
a tracking area identifier of the system information supporting verification; or
an access network notification area identifier of the system information supporting verification.

Optionally, in an embodiment of the present disclosure, the apparatus is further configured to:
send the configuration information to the UE through a broadcast message; or
send the configuration information to the UE through a dedicated configuration message.

Optionally, in an embodiment of the present disclosure, the verification module is further configured to:
determine a first verification algorithm; where the first verification algorithm is any one of verification algorithms supported by the UE;
execute calculation on to-be-verified system information with the first verification algorithm to obtain a first value; where the to-be-verified system information includes at least one of: the system information expected to be verified by the UE, the system information received by the UE, or the system information of interest of the UE;
send the first value to the UE; and
obtain a verification result sent by the UE; where the verification result indicates verification failure.

Optionally, in an embodiment of the present disclosure, the verification module is further configured to:
determine a first verification algorithm; where the first verification algorithm is any one of verification algorithms supported by the UE;
execute calculation on to-be-verified system information with the first verification algorithm to obtain a first value; where the to-be-verified system information includes at least one of: the system information expected to be verified by the UE, the system information received by the UE, or the system information of interest of the UE;
send information of the first verification algorithm and second indication information to the UE; where the second indication information is to instruct the UE to execute the correctness verification for system information;
obtain a second value sent by the UE; and
determine whether the first value matches the second value; when the first value matches the second value, determine a verification result as verification success; and when the first value does not match the second value, determine the verification result as verification failure.

Optionally, in an embodiment of the present disclosure, the apparatus is further configured to:
send verification result information to the UE; where the verification result information includes at least one of:
a verification result of executing the correctness verification for system information; where the verification result indicates verification success or verification failure;
an area identifier of system information which undergoes the correctness verification;
third indication information indicating whether the system information is subjected to a security problem; or
fourth indication information including a type indication of the security problem subjected by the system information, where the type indication includes an indication indicating system information correctness verification failure and/or an indication indicating system information tampered.

Optionally, in an embodiment of the present disclosure, the apparatus is further configured to:
in response to that the verification result indicates verification failure, re-send the system information to the UE.

Optionally, in an embodiment of the present disclosure, the apparatus is further configured to:
determine whether the system information is subjected to a security problem.

Optionally, in an embodiment of the present disclosure, the apparatus is further configured to:
determine whether the system information is subjected to a security problem based on the verification result; or
determine whether the system information is subjected to a security problem based on the number of times of the network-side device sending system information.

Optionally, in an embodiment of the present disclosure, the apparatus is further configured to:
determine the number of verification failures for the system information, and in response to that the number of verification failures exceeds a first threshold, determine that the system information is subjected to a security problem.

Optionally, in an embodiment of the present disclosure, the number of verification failures indicates the number of verification failures for the same system information.

Optionally, in an embodiment of the present disclosure, the number of verification failures indicates the number of continuous verification failures for the same system information.

Optionally, in an embodiment of the present disclosure, the apparatus is further configured to:
determine the number of times of sending the system information, and in response to that the number of times of sending system information exceeds a second threshold, determine that the system information is subjected to a security problem.

Optionally, in an embodiment of the present disclosure, the number of times of sending system information indicates the number of times of sending same system information.

Optionally, in an embodiment of the present disclosure, the number of times of sending system information indicates the number of times of continuously sending the same system information.

Optionally, in an embodiment of the present disclosure, the apparatus is further configured to:
enter a connection release, to execute cell selection or re-selection;
enter a connection reconstruction, to execute the cell selection or re-selection; or
obtain fifth indication information sent by the UE, where the fifth indication information is to indicate a situation of the system information being subjected to a security problem.

Optionally, in an embodiment of the present disclosure, the apparatus is further configured to:
receive the fifth indication information and/or a connection release indication sent by the UE.

Optionally, in an embodiment of the present disclosure, the apparatus is further configured to:
receive the fifth indication information and/or a connection reconstruction request message sent by the UE.

Optionally, in an embodiment of the present disclosure, the apparatus is further configured to:
reduce a selection priority of a cell or a frequency point in which the system information is subjected to a security problem; and/or
ignore the cell or the frequency point in which the system information is subjected to a security problem.

Optionally, in an embodiment of the present disclosure, the fifth indication information includes at least one of:
an identifier of the system information being subjected to a security problem;
fourth indication information including a type indication of the security problem subjected by the system information, where the type indication includes an indication indicating system information correctness verification failure and/or an indication indicating system information tampered; or
an area identifier of the system information being subjected to a security problem.

Optionally, in an embodiment of the present disclosure, the apparatus is further configured to:
determine the area identifier of the system information being subjected to a security problem including at least one of:
a cell identifier of the system information being subjected to a security problem;
a cell type identifier of the system information being subjected to a security problem;
a cell group type identifier of the system information being subjected to a security problem;
a tracking area identifier of the system information being subjected to a security problem; or
an access network notification area identifier of the system information being subjected to a security problem.

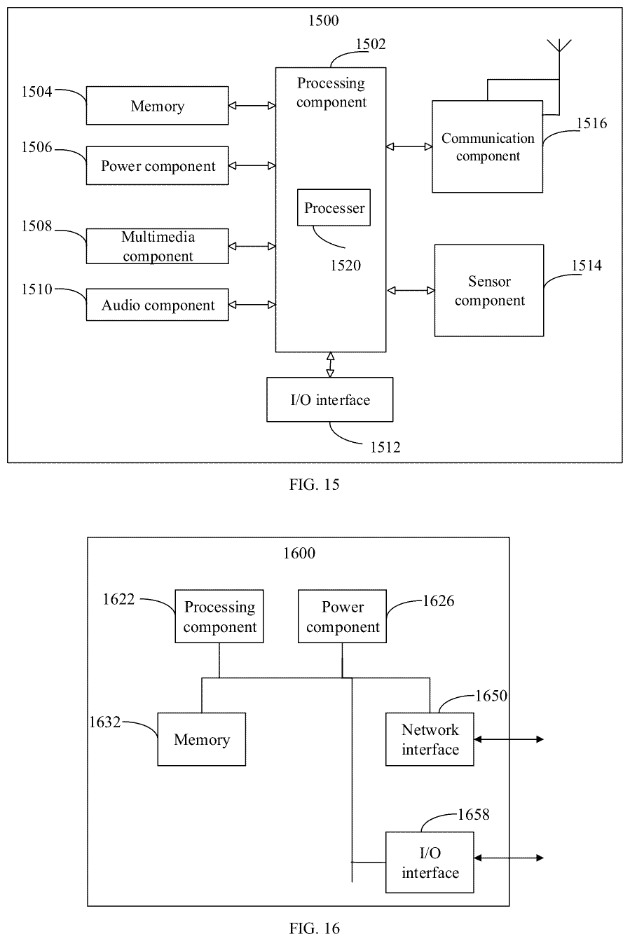

FIG. 15 is a block diagram of user equipment (UE) 1500 provided by an embodiment of the present disclosure. For example, the UE 1500 may be a mobile phone, a computer, a digital broadcast terminal device, a message transceiving device, a game console, a tablet device, a medical device, a fitness device, a personal digital assistant, etc.

Referring to FIG. 15, the UE 1500 may include at least one of the following components: a processing component 1502, a memory 1504, a power component 1506, a multimedia component 1508, an audio component 1510, an input/output (I/O) interface 1512, a sensor component 1514, and a communication component 1516.

The processing component 1502 typically controls the overall operation of the UE 1500, such as operations associated with display, phone calls, data communication, camera operations, and recording operations. The processing component 1502 may include at least one processer 1520 to execute instructions to complete all or part of the steps in the above methods. Additionally, the processing component 1502 may include at least one module to facilitate interaction between the processing component 1502 and other components. For example, the processing component 1502 may include a multimedia module to facilitate interaction between the multimedia component 1508 and the processing component 1502.

The memory 1504 is configured to store various types of data to support operations of the UE 1500. Examples of such data include instructions, contact data, phonebook data, messages, pictures, videos, etc., for any application program or method operating on the UE 1500. The memory 1504 may be realized by any type of volatile or non-volatile storage device or their combination, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk.

The power component 1506 provides power to various components of the UE 1500. The power component 1506 may include a power supply management system, at least one power supply, and other components that are associated with generating, managing, and distributing power for the UE 1500.

The multimedia component 1508 includes a screen providing an output interface between the UE 1500 and the user. In some embodiments, the screen may include a liquid crystal display (LCD) and a touch panel (TP). If the screen includes the touch panel, the screen may be implemented as a touch screen, to receive an input signal from the user. The touch panel includes at least one touch sensor to sense the touch, the slide, and the gesture on the touch panel. The touch sensor may not only sense a boundary of the touch or slide action, but also detect a wake-up time and pressure related to the touch or slide operation. In some embodiments, the multimedia component 1508 includes a front facing camera and/or a rear facing camera. When the UE 1500 is in an operation mode, such as a shooting mode or a video mode, the front facing camera and/or the rear facing camera may receive external multimedia data. Each of the front facing camera and rear facing camera may be a fixed optical lens system or have a focal length and an optical zoom capability.

The audio component 1510 is configured to output and/or input audio signals. For example, the audio component 1510 includes a microphone (MIC). The microphone is configured to receive external audio signals when the UE 1500 is in the operating mode, such as a call mode, a recording mode, and a speech recognition mode. The received audio signals may be further stored in the memory 1504 or sent via the communication component 1516. In some embodiments, the audio component 1510 also includes a speaker for outputting the audio signals.

The I/O interface 1512 provides an interface between the processing component 1502 and peripheral interface modules. The above peripheral interface modules may be keyboards, click wheels, buttons, etc. These buttons may include but are not limited to: a home button, a volume button, a start button, and a lock button.

The sensor component 1514 includes at least one sensor to provide various aspects of state assessment for the UE 1500. For example, the sensor component 1514 may detect an open/closed state of the UE 1500, relative positioning of components that are for example a display and keypad of the UE 1500. The sensor component 1514 may also detect a position change of the UE 1500 or of a component of the UE 1500, presence or absence of the user contacting with the UE 1500, an orientation or acceleration/deceleration of the UE 1500, and a temperature change of the UE 1500. The sensor component 1514 may include a proximity sensor configured to detect the presence of nearby objects without any physical contact. The sensor component 1514 may also include a light sensor, such as a CMOS or CCD image sensor, for use in an imaging application. In some embodiments, the sensor component 1514 may also include an acceleration sensor, a gyroscope sensor, a magnetic sensor, a pressure sensor, or a temperature sensor.

The communication component 1516 is configured to facilitate wired or wireless communication between the UE 1500 and other devices. The UE 1500 may access a wireless network based on a communication standard, such as WiFi, 2G, 3G, or a combination of them. In an exemplary embodiment, the communication component 1516 receives, via a broadcast channel, a broadcast signal or broadcast related information from an external broadcast management system. In an exemplary embodiment, the communication component 1516 further includes a near-field communication (NFC) module to facilitate short-range communication. For example, the NFC module may be implemented based on a radio frequency identification (RFID) technology, an infrared data association (IrDA) technology, an ultra-wideband (UWB) technology, a Bluetooth (BT) technology, and other technologies.

In an exemplary embodiment, the UE 1500 may be implemented by at least one application specific integrated circuit (ASIC), digital signal processor (DSP), digital signal processing device (DSPD), programmable logic device (PLD), field programmable gate array (FPGA), controller, microcontroller, microprocessor, or other electronic component to execute the above methods.

FIG. 16 is a block diagram of a network-side device 1600 provided by an embodiment of the present disclosure. For example, the network-side device 1600 may be provided as one network-side device. Referring to FIG. 16, the network-side device 1600 includes a processing component 1622 that further includes at least one processor, and memory resources represented by a memory 1632, to store instructions that is executable by the processing component 1622, such as an application program. The application program stored in the memory 1632 may include one or more modules that each corresponds to a set of instructions. In addition, the processing component 1622 is configured to execute instructions to execute any method applied to the network-side device in the above methods, for example, the method shown in FIG. 1.

The network-side device 1600 may also include a power component 1626 configured to execute power management of the network-side device 1600, a wired or wireless network interface 1650 configured to connect the network-side device 1600 to the network, and an input/output (I/O) interface 1658. The network-side device 1600 may operate an operating system stored in the memory 1632, such as Windows Server™, Mac OS X™, Unix™, Linux™, Free BSD™, or a similar operating system.

In the above embodiments provided by the present disclosure, the methods provided by the embodiments of the present disclosure is introduced respectively from the perspectives of the network-side device and the UE. To implement various functions in the methods provided by the embodiments of the present disclosure, the network-side device and the UE may include a hardware structure and a software module, to implement the above functions in a form of the hardware structure, the software module, or a combination of the hardware structure and the software module. A certain function in the above functions may be executed by using a hardware structure, a software module, or a combination of the hardware structure and the software module.

In the above embodiments provided by the present disclosure, the methods provided by the embodiments of the present disclosure is introduced respectively from the perspectives of the network-side device and the UE. To implement various functions in the methods provided by the embodiments of the present disclosure, the network-side device and the UE may include a hardware structure and a software module, to implement the above functions in a form of the hardware structure, the software module, or a combination of the hardware structure and the software module. A certain function in the above functions may be executed by using a hardware structure, a software module, or a combination of the hardware structure and the software module.

An embodiment of the present disclosure provides a communication apparatus. The communication apparatus may include a transceiving module and a processing module. The transceiving module may include a sending module and/or a receiving module. The sending module is configured to implement a sending function, the receiving module is configured to implement a receiving function, and the transceiving module may implement the sending function and/or the receiving function.

The communication apparatus may be a terminal device (for example, the terminal device in the above method embodiments), may be an apparatus in the terminal device, or may be an apparatus that can be matched with the terminal device for use. Alternatively, the communication apparatus may be a network device, may be an apparatus in the network device, or may be an apparatus that can be matched with the network device for use.

An embodiment of the present disclosure provides another communication apparatus. The communication apparatus may be a network device, or may be a terminal device (for example, the terminal device in the above method embodiments), or may be a chip, a chip system, or a processor that supports the network device to implement the above methods, etc., or may be a chip, a chip system, or a processor that supports the terminal device to implement the above methods. This apparatus may be configured to implement the methods described in the above method embodiments, which may specifically refer to the description in the above method embodiments.

The communication apparatus may include one or more processors. The processors may be general-purpose processors, special-purpose processors, etc. For example, the processors may be baseband processors or central processing units. The baseband processor may be configured to process a communication protocol and communication data, and the central processing unit may be configured to control the communication apparatus (for example, a network-side device, a baseband chip, a terminal device, a terminal device chip, a DU, a CU, etc.), execute a computer program, and process data of the computer program.

Optionally, the communication apparatus may further include one or more memories. The one or more memories may store a computer program, and the processor executes the computer program to cause the communication apparatus to execute the methods described in the above method embodiments. Optionally, the memory may further store data. The communication apparatus and the memory may be separately configured, or may be integrated together.

Optionally, the communication apparatus may further include a transceiver and an antenna. The transceiver may be referred to as a transceiver unit, a transceiver machine, a transceiver circuit, etc., and is configured to implement a transceiver function. The transceiver may include a receiver and a sender. The receiver may be referred to as a receiving machine, a receiving circuit, etc., and is configured to implement a receiving function. The sender may be referred to as a sending machine, a sending circuit, etc., and is configured to implement a sending function.

Optionally, the communication apparatus may further include one or more interface circuits. The interface circuits are configured to receive code instructions and transmit the code instructions to the processor. The processor executes the code instructions to cause the communication apparatus to execute the methods described in the above method embodiments.

The communication apparatus is a terminal device (for example, the terminal device in the above method embodiments), and the processor is configured to execute any method shown in FIG. 1, FIG. 2, FIG. 3, FIG. 4a, and FIG. 4b.

The communication apparatus is a network device, and the transceiver is configured to execute any method shown in FIGS. 5-7.

In an implementation, the processor may include a transceiver for implementing the receiving and sending functions. For example, the transceiver may be a transceiver circuit, an interface, or an interface circuit. The transceiver circuit, the interface, or the interface circuit for implementing the receiving and sending functions may be separate or integrated together. The above transceiver circuit, interface, or interface circuit may be configured to read and write codes/data, or the above transceiver circuit, interface, or interface circuit may be configured to transmit or transfer a signal.

In an implementation, the processor may store a computer program, and the computer program runs on the processor, such that the communication apparatus may execute the methods described in the above method embodiments. The computer program may be fixed in the processor, and in this situation, the processor may be implemented by hardware.

In an implementation, the communication apparatus may include a circuit, and the circuit may implement sending, receiving, or communicating functions in the above method embodiments. The processor and transceiver described in the present disclosure may be implemented on integrated circuits (ICs), analog ICs, radio frequency integrated circuits (RFICs), mixed signal ICs, application specific integrated circuits (ASICs), printed circuit boards (PCBs), electronic devices, etc. The processor and transceiver may also be fabricated with various IC process technologies, such as a complementary metal oxide semiconductor (CMOS), an n-metal oxide semiconductor (NMOS), a p-metal oxide semiconductor (positive channel metal oxide semiconductor, PMOS), a bipolar junction transistor (BJT), a bipolar CMOS (BiCMOS), a silicon germanium (SiGe), a gallium arsenide (GaAs), etc.

The communication apparatus described in the above embodiments may be a network device or a terminal device (for example, the terminal device in the above method embodiments), but a scope of the communication apparatus described in the present disclosure is not limited thereto, and a structure of the communication apparatus may not be limited. The communication apparatus may be a separate device or may be a part of a larger device. For example, the communication apparatus may be:
(1) a separate integrated circuit IC, chip, or chip system or subsystem;
(2) a set of one or more ICs; optionally, the set of ICs may also include a storage component storing data and a computer program;
(3) an ASIC, for example, a modem;
(4) a module that may be embedded within other devices;
(5) a receiving machine, a terminal device, an intelligent terminal device, a cellular phone, a wireless device, a handset, a mobile unit, an in-vehicle device, a network device, a cloud device, an artificial intelligence device, etc.; or
(6) other apparatus, etc.

In the case that the communication apparatus may be a chip or a chip system, the chip includes a processor and an interface. There may be one or more processors, and there may be multiple interfaces.

Optionally, the chip further includes a memory, and the memory is configured to store a necessary computer program and data.

Those skilled in the art may also understand that various illustrative logical blocks and steps listed in the embodiments of the present disclosure may be implemented by using electronic hardware, computer software, or a combination of the two. Whether such functions are implemented by hardware or software depends on specific applications and design requirements of an overall system. Those skilled in the art may use various methods to implement the functions for each specific application, but this implementation should not be understood as going beyond the protection scope of the embodiments of the present disclosure.

The present disclosure further provides a readable storage medium storing instructions. When the instructions are executed by a computer, functions of any one of the above method embodiments are implemented.

The present disclosure further provides a computer program product. When the computer program product is executed by a computer, the functions of any one of the above method embodiments are implemented.

In the above embodiments, it may be implemented in whole or in part by software, hardware, firmware, or any combination thereof. When implemented in software, it may be implemented in whole or in part in the form of a computer program product. The computer program product includes one or more computer programs. When the computer programs are loaded and executed by a computer, the flows or functions according to embodiments of the present disclosure are generated in whole or in part. The computer may be a general purpose computer, a special purpose computer, a computer network, or other programmable apparatus. The computer programs may be stored in a computer readable storage medium or transmitted from one computer readable storage medium to another computer readable storage medium. For example, the computer programs may be transmitted from a website site, computer, server or data center to another website site, computer, server or data center by a wired (for example, a coaxial-cable, a fiber, a digital subscriber line (DSL)) or wirelessly (for example, infrared, wireless, microwave, etc.) manner. The computer readable storage medium may be any available medium that can be accessed by a computer or may be a data storage device, such as a server, data center, or the like, including one or more integrated available mediums. The available medium may be a magnetic medium (for example, a floppy disk, a hard disk, a magnetic tape), an optical medium (for example, a high-density digital video disc (DVD)), or a semiconductor medium (for example, a solid state disk (SSD)), etc.

Those skilled in the art may understand that various numerical numbers such as “first” and “second” involved in the present disclosure are only for distinguishing for the convenience of description and are not intended to limit the scope of the embodiments of the present disclosure, and do not also represent an early-later sequence.

“At least one” in the present disclosure may also be described as one or more, and “a plurality of/multiple” may be two, three, four or more, which is not limited in the present disclosure. In the embodiments of the present disclosure, for a kind of technical features, technical features in the kind of technical features are distinguished by “first”, “second”, “third”, “A”, “B”, “C”, and “D”, etc., and there is no an early-later sequence or a large-mall sequence among the technical features described by “first”, “second”, “third”, “A”, “B”, “C”, and “D”.

Those skilled in the art will easily come up with other implementation solutions of the present disclosure after considering the specification and practicing the present disclosure disclosed herein. The present disclosure aims to cover any variations, uses, or adaptive changes of the present disclosure, which follow general principles of the present disclosure and include common knowledge or customary technical means in the art not disclosed in the present disclosure. The specification and embodiments are only considered exemplary, and the true scope and spirit of the present disclosure are indicated by the following claims.

It should be understood that the present disclosure is not limited to the precise structure described above and shown in the accompanying drawings, and various modifications and changes may be made without departing from its scope. The scope of the present disclosure is limited only by the appended claims.

An embodiment in a seventh aspect of the present disclosure provides a system information verification apparatus. The apparatus includes:
a sending module, configured to send auxiliary information to a network-side device; where the auxiliary information includes at least one of: a verification manner supported by the UE, information of a verification algorithm supported by the UE, an identifier of system information expected to be verified by the UE, an identifier of system information received by the UE, an identifier of system information of interest of the UE, or first indication information indicating that the UE expects system information verification; and
a verification module, configured to obtain information that is sent by a network-side device based on the auxiliary information, and trigger correctness verification for system information based on information sent by the network-side device.

An embodiment in an eighth aspect of the present disclosure provides a system information verification apparatus. The apparatus includes:
an obtaining module, configured to obtain auxiliary information sent by UE; where the auxiliary information includes at least one of: a verification manner supported by the UE, information of a verification algorithm supported by the UE, an identifier of system information expected to be verified by the UE, an identifier of system information received by the UE, an identifier of system information of interest of the UE, or first indication information indicating that the UE expects system information verification; and
a verification module, configured to trigger correctness verification for system information based on the auxiliary information.

An embodiment in a ninth aspect of the present disclosure provides a communication apparatus. The apparatus includes a processor and a memory. The memory stores a computer program, and the processor executes the computer program stored in the memory, to cause the apparatus to execute the method provided in the embodiment in the first aspect.

An embodiment in a ten aspect of the present disclosure provides a communication apparatus. The apparatus includes a processor and a memory. The memory stores a computer program, and the processor executes the computer program stored in the memory, to cause the apparatus to execute the method provided in the embodiment in the second aspect.

1. A system information verification method, applied to user equipment (UE) and comprising:
sending auxiliary information to a network-side device; wherein the auxiliary information comprises at least one of:
a verification manner supported by the UE;
information of a verification algorithm supported by the UE;
an identifier of system information expected to be verified by the UE;
an identifier of system information received by the UE;
an identifier of system information of interest of the UE; or
first indication information indicating that the UE expects system information verification; and
triggering, based on information sent by the network-side device, correctness verification for system information.

2. The method of claim 1, further comprising:
obtaining configuration information sent by the network-side device; wherein the configuration information comprises at least one of:
a verification manner supported by the network-side device;
an area identifier of system information supporting verification;
a first request message for requesting the UE to report whether the UE is capable of supporting system information verification, and/or for requesting the UE to report the information of the verification algorithm supported by the UE;
a second request message for requesting the UE to report the identifier of the system information expected to be verified by the UE;
a third request message for requesting the UE to report the identifier of the system information received by the UE; or
a fourth request message for requesting the UE to report the identifier of the system information of interest of the UE.

3. The method of claim 2, wherein the sending auxiliary information to a network-side device comprises:
sending, based on the configuration information, the auxiliary information to the network-side device.

4. The method of claim 1- or 2, wherein the verification manner comprises at least one of:
executing, by the UE, the correctness verification for system information; or
executing, by the network-side device, the correctness verification for system information.

5. The method of claim 1 or 2, wherein the information of the verification algorithm supported by the UE comprises at least one of:
an algorithm type identifier of the verification algorithm supported by the UE; or
an algorithm identifier of the verification algorithm supported by the UE.

6. The method of claim 2, wherein the area identifier of the system information supporting verification comprises at least one of:
a cell identifier of the system information supporting verification;
a cell type identifier of the system information supporting verification;
a cell group type identifier of the system information supporting verification;
a tracking area identifier of the system information supporting verification; or
an access network notification area identifier of the system information supporting verification.

7. The method of claim 2, wherein the obtaining configuration information sent by the network-side device is realized by at least one of:
obtaining the configuration information sent by the network-side device through a broadcast message; or
obtaining the configuration information sent by the network-side device through a dedicated configuration message.

8. The method of claim 1, wherein the triggering, based on information sent by the network-side device, correctness verification for system information comprises:
obtaining information of a first verification algorithm;
executing calculation on to-be-verified system information with the first verification algorithm to obtain a second value; wherein the to-be-verified system information comprises at least one of: the system information expected to be verified by the UE, the system information received by the UE, or the system information of interest of the UE;
sending the second value to the network-side device to obtain verification result information sent by the network-side device; or,
determining, based on second indication information received from the network-side device, whether a first value received from the network-side device matches the second value; when the first value does not match the second value, determining a verification result as verification failure; and in response to that the verification result indicates verification failure, sending the verification result to the network-side device;
wherein the second indication information is to instruct the UE to execute the correctness verification for system information;
wherein the verification result information comprises at least one of:
a verification result of executing the correctness verification for system information; wherein the verification result indicates verification success or verification failure;
an area identifier of system information which undergoes the correctness verification;
third indication information indicating whether the system information is subjected to a security problem; or
fourth indication information comprising a type indication of the security problem subjected by the system information; wherein the type indication comprises an indication indicating system information correctness verification failure and/or an indication indicating system information tampered.

9-12. (canceled)

13. The method of claim 128, further comprising at least one of:
in response to that the verification result indicates the verification failure, obtaining system information re-sent by the network-side device;
determining, based on the verification result, whether the system information is subjected to a security problem; or
determining, based on a number of times of the UE receiving system information, whether the system information is subjected to a security problem.

14. The method of claim 13, wherein the determining, based on the verification result, whether the system information is subjected to a security problem comprises:
determining a number of verification failures for the system information; and
in response to that the number of verification failures exceeds a first threshold, determining that the system information is subjected to a security problem;
wherein the number of verification failures indicates a number of verification failures for same system information.

15-16. (canceled)

17. The method of claim 13, wherein the determining, based on a number of times of the UE receiving system information, whether the system information is subjected to a security problem comprises:
determining a number of times of receiving system information, and in response to that the number of times of receiving system information exceeds a second threshold, determining that the system information is subjected to a security problem;
wherein the number of times of receiving system information indicates a number of times of receiving same system information.

18-19. (canceled)

20. The method of claim 128, further comprising at least one of:
in response to determining that the system information is subjected to a security problem, triggering a connection release to execute cell selection or re-selection;
in response to determining that the system information is subjected to a security problem, triggering a connection reconstruction to execute the cell selection or re-selection; or
in response to determining that the system information is subjected to a security problem, reporting fifth indication information to the network-side device; wherein the fifth indication information is to indicate a situation of the system information being subjected to a security problem.

21.-25. (canceled)

26. A system information verification method, applied to a network-side device and comprising:
obtaining auxiliary information sent by UE; wherein the auxiliary information comprises at least one of:
a verification manner supported by the UE;
information of a verification algorithm supported by the UE;
an identifier of system information expected to be verified by the UE;
an identifier of system information received by the UE;
an identifier of system information of interest of the UE; or
first indication information indicating that the UE expects system information verification; and
triggering, based on the auxiliary information, correctness verification for system information.

27-32. (canceled)

33. The method of claim 26, wherein the triggering, based on the auxiliary information, correctness verification for system information comprises:
determining a first verification algorithm; wherein the first verification algorithm is any one of verification algorithms supported by the UE;
executing calculation on to-be-verified system information with the first verification algorithm to obtain a first value; wherein the to-be-verified system information comprises at least one of: the system information expected to be verified by the UE, the system information received by the UE, or the system information of interest of the UE;
sending second indication information and the first value to the UE, to
obtain a verification result sent by the UE; wherein the verification result indicates verification failure; or
obtaining a second value sent by the UE; determining whether the first value matches the second value; when the first value does not match the second value, determining a verification result as verification failure; and sending verification result information to the network-side device;
wherein the second indication information is to instruct the UE to execute the correctness verification for system information;
wherein the verification result information comprises at least one of:
a verification result of executing the correctness verification for system information; wherein the verification result indicates verification success or verification failure;
an area identifier of system information which undergoes the correctness verification:
third indication information indicating whether the system information is subjected to a security problem; or
fourth indication information comprising a type indication of the security problem subjected by the system information; wherein the type indication comprises an indication indicating system information correctness verification failure and/or an indication indicating system information tampered.

34.-37. (canceled)

38. The method of claim 3733, further comprising at least of:
in response to that the verification result indicates verification failure, re-sending system information to the UE;
determining, based on the verification result, whether the system information is subjected to a security problem; or
determining, based on a number of times of the network-side device sending system information, whether the system information is subjected to a security problem.

39. The method of claim 38, wherein,
the determining, based on the verification result, whether the system information is subjected to a security problem comprises:
determining a number of verification failures for the system information; and
in response to that the number of verification failures exceeds a first threshold, determining that the system information is subjected to a security problem; wherein the number of verification failures indicates a number of verification failures for same system information;
or,
the determining, based on a number of times of the network-side device sending system information, whether the system information is subjected to a security problem comprises:
determining a number of times of sending system information; and
in response to that the number of times of sending system information exceeds a second threshold, determining that the system information is subjected to a security problem; wherein the number of times of sending system information indicates a number of times of receiving same system information.

40-54. (canceled)

55. A communication apparatus, comprising: a processor and an interface circuit;
wherein the interface circuit is configured to receive code instructions and transmit the code instructions to the processor; and
the processor is configured to execute the code instructions to execute the method of claim 1.

56. A communication apparatus, comprising: a processor and an interface circuit;
wherein the interface circuit is configured to receive code instructions and transmit the code instructions to the processor; and
the processor is configured to execute the code instructions to execute the method of claim 26.

57. A non-transitory computer-readable storage medium, configured to store instructions, wherein when the instructions are executed, the method of claim 1 executed.

58. A non-transitory computer-readable storage medium, configured to store instructions, wherein when the instructions are executed, the method of claim 26 executed.
